(19) United States
(12) Patent Application Publication
(10) Pub. No.: US 2015/0287403 A1
(43) Pub. Date: Oct. 8, 2015

(54) DEVICE, SYSTEM, AND METHOD OF AUTOMATICALLY GENERATING AN ANIMATED CONTENT-ITEM

(71) Applicants: Neta Holzer Zaslansky, Bney Zion (IL); Alon Dalah, Ramat HaSharon (IL)

(72) Inventors: Neta Holzer Zaslansky, Bney Zion (IL); Alon Dalah, Ramat HaSharon (IL)

(21) Appl. No.: 14/676,825

(22) Filed: Apr. 2, 2015

Related U.S. Application Data
(60) Provisional application No. 61/975,939, filed on Apr. 7, 2014.

(51) Int. Cl. G10L 15/08; G06T 13/20; G10L 17/22

(52) U.S. Cl. CPC G10L 15/08; G10L 17/22; G06T 13/205

(57) ABSTRACT

Device, system, and method of automatically generating animated content-items. A user operates a smartphone, a tablet, a smart-watch, a computer, or other electronic device, to record an audio segment, and to select a graphical avatar. The audio segment is analyzed by a module that recognizes audio phonemes, and that divides the audio segments into a set of ordered, discrete, audio phonemes. Each audio phoneme is matched with a suitable image that shows the graphical avatar selected by the user, at a particular facial gesture or temporal state that corresponds to utterance of that audio phoneme. An animation sequence is produced, as a data-item or as stand-alone audio/video file. The animated sequence further reflects emotions or mood or other expressions that are identified in the original audio segment. The animation sequence is sent to selected recipients; or is distributed or shared via sharing methods or distribution channels.

### CROSS-REFERENCE TO RELATED APPLICATIONS

This patent application claims priority and benefit from U.S. provisional patent application No. 61/975,939, filed on Apr. 7, 2014, which is incorporated herein by reference in its entirety.

### FIELD OF THE INVENTION

The invention relates to the field of electronic communications.

### BACKGROUND

Millions of people use portable electronic devices for daily communications. For example, cellular phones and smartphones are used to allow two persons to conduct a voice conversation. Similarly, a first user may utilize a video conferencing application, such as Skype or FaceTime, to conduct a video conference with a second user.

Users further utilize electronic devices in order to exchange textual messages. For example, a first user may send an electronic mail (email) message to a second user. Similarly, the first user may utilize a cellular phone or a smartphone to send a text message (SMS or Short Message Service) to a second user who also utilizes a cellular phone or smartphone.

Many users utilize a dedicated application or “app” for instant messaging (IM). For example, a user may utilize the “WhatsApp” messaging application in order to exchange messages with another user, or with a group of users.

### SUMMARY

The present invention may comprise devices, systems, and methods of automatically generating animated content-items. For example, a user operates a smartphone, a tablet, a smart-watch, a computer, or other electronic device, to record an audio segment, and to select a graphical avatar. The audio segment is analyzed by a module that recognizes audio phonemes, and that divides the audio segments into a set of ordered, discrete, audio phonemes. Each audio phoneme is matched with a suitable image that shows the graphical avatar selected by the user, at a particular facial gesture or temporal state that corresponds to utterance of that audio phoneme. An animation sequence is produced, as a data-item or as stand-alone audio/video file. The animated sequence further reflects emotions or mood or other expressions that are identified in the original audio segment. The animation sequence is sent to selected recipients; or is distributed or shared via sharing methods or distribution channels.

The present invention may further comprise devices, systems, and methods of animated voice messaging, as well as automatic generation of animated clip based on captured audio. For example, a sender utilizes a first smartphone to select a graphical avatar and to record a voice-message intended to reach a recipient. The voice-message is analyzed by a module that recognizes audio phonemes, and that divides the voice-message into a set of ordered, discrete, audio phonemes. Each audio phoneme is matched with a suitable image that shows the graphical avatar of the sender, at a particular facial gesture that corresponds to utterance of that audio phoneme. An animation sequence is produced, and is transmitted to the recipient's smartphone or other electronic device; which then plays-back the animation sequence of the graphical avatar together with audio play-back of the voice-message. Optionally, the animated sequence or clip further reflects emotions or mood or other expressions that are identified in the original audio message.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments of the present invention;

FIG. 2 is a table demonstrating image frames of a mouth of an avatar, corresponding to various phonemes that are recognized in a voice-message, in accordance with some demonstrative embodiments of the present invention;

FIG. 3 is a schematic illustration demonstrating an application wireframe, in accordance with a demonstrative example of an implementation of the present invention;

FIG. 4 is a schematic illustration of a Contacts screen, in accordance with some demonstrative embodiments of the present invention;

FIG. 5 is a schematic illustration of a Conversations screen, in accordance with some demonstrative embodiments of the present invention;

FIG. 6 is a schematic illustration of a Compose Message screen, in accordance with some demonstrative embodiments of the present invention;

FIG. 7 is a schematic illustration of a wireframe flow of screens, in accordance with some demonstrative embodiments of the present invention;

FIG. 8 is a schematic illustration of another wireframe flow of screens, in accordance with some other demonstrative embodiments of the present invention;

FIG. 9 is a schematic illustration of a system demonstrating a flow, in accordance with some embodiments of the present invention;

FIG. 10A is a table demonstrating phonemes that correspond to consonants, in accordance with some demonstrative embodiments of the present invention;

FIG. 10B is a table demonstrating phonemes that correspond to vowels, in accordance with some demonstrative embodiments of the present invention;

FIG. 11 is a schematic block-diagram illustration of interactions in a client/server system, in accordance with some demonstrative embodiments of the present invention; and

FIG. 12 is a schematic illustration of a smart-watch, in accordance with some demonstrative embodiments of the present invention.

### DESCRIPTION OF SOME DEMONSTRATIVE EMBODIMENTS OF THE PRESENT INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

At an overview, the present invention allows a first user to utilize a smartphone or a cellular phone (or other suitable mobile device or electronic device) in order to select an avatar and to record a voice-message intended to reach a second user. The voice-message is uploaded or transmitted (e.g., from the user's smartphone) to a server, and the system constructs (e.g., on the server; or on the recipient device; or on the sender device) an animation sequence that corresponds to phonemes that are identified (by the system) in the recorded voice-message. The voice-message and the corresponding animation are then “pushed” or delivered or downloaded or transmitted to the recipient device, where they are played-back to the recipient user, in synchronization (e.g., such that a suitable animation or image appears on the screen when a certain phoneme or syllable or audio is heard).

The present invention may comprise device, system, and method of automatically generating animated content-items. For example, a user operates a smartphone, a tablet, a smart-watch, a computer, or other electronic device, to record an audio segment, and to select a graphical avatar. The audio segment is analyzed by a module that recognizes audio phonemes, and that divides the audio segments into a set of ordered, discrete, audio phonemes. Each audio phoneme is matched with a suitable image that shows the graphical avatar selected by the user, at a particular facial gesture or temporal state that corresponds to utterance of that audio phoneme. An animation sequence is produced, as a data-item or as stand-alone audio/video file. Optionally, the animated sequence further reflects emotions or mood or other expressions that are identified in the original audio segment. Optionally, the animation sequence is sent to selected recipients; or is distributed or shared via sharing methods or distribution channels.

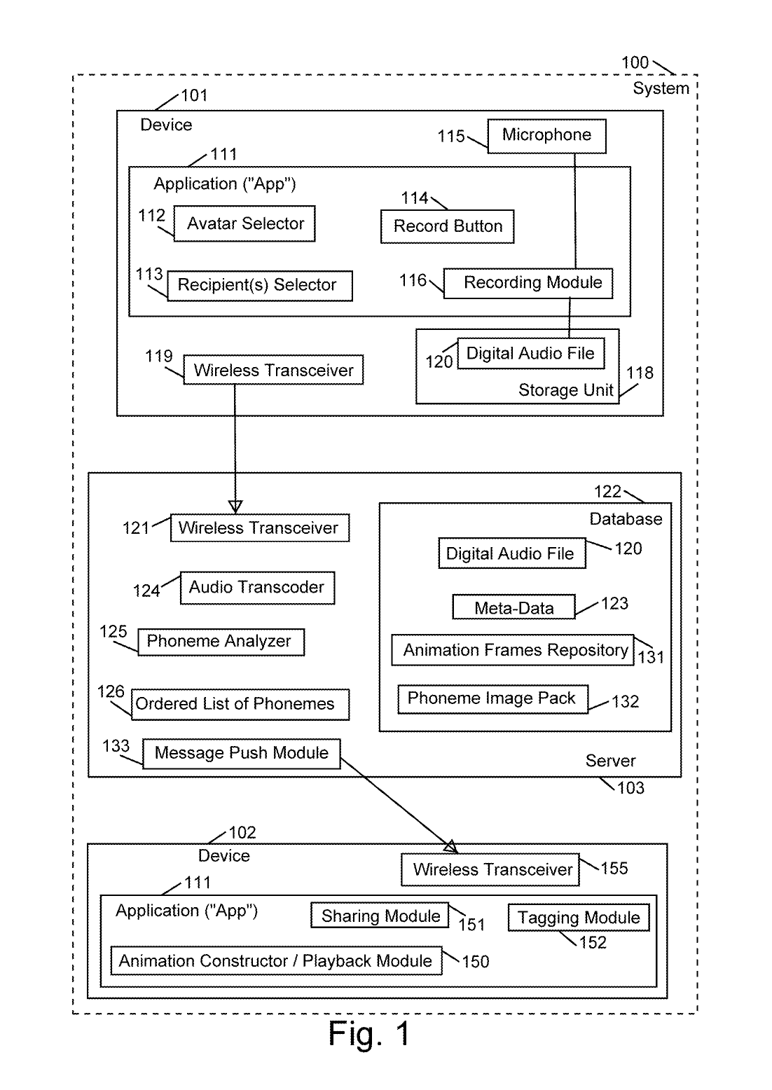

Reference is made to FIG. 1, which is a schematic block diagram illustration of a system 100 in accordance with some demonstrative embodiments of the present invention. System 100 may comprise, for example, a first end-user device 101, a second end-user device 102, and a server 103. The units of system 100 may be able to communicate by using wired and/or wireless communication links, via Internet communication protocol(s), via wireless communication protocol(s), via cellular communication protocol(s), via 2G or 3G or 4G or 4G-LTE communication, or other suitable methods of communication. Units of system 100, or their sub-unit(s), may be implemented by utilizing any suitable combination of hardware components and/or software modules.

Each one of devices 101-102 may be or may comprise, for example, a smartphone, a tablet, a portable electronic device, a laptop computer, a desktop computer, a gaming device, a wireless communication device, a phone-tablet or “phablet” device, a wearable device, a smart-watch device, an Augmented Reality (AR) device, a projector device, a wearable device similar to Google Glass, and/or other suitable electronic device or appliance.

Server 103 may be or may comprise, for example, a web server, a database, an application(s) server, a “cloud computing” or “big data” server or device or infrastructure, or the like. Server 103 may optionally comprise multiple modules, which may be co-located or may be distributed across multiple locations. It is noted that in some implementations, system 100 may not comprise a remote or separate or stand-alone server (such as server 103); but rather, some or all of the operations that are described herein as being performed by (or within) server 103 may actually be implemented as operations and/or modules of device 101.

By utilizing the system, the user of device 101 (“sender”) may compose and send an animated voice-message to the user of device 102 (“recipient”), or to multiple users or a group of users; or to a pre-defined audience or to a general audience (e.g., a group of friends on a social media website or on a social network; the general public; a pod-cast or multimedia pod-cast to a group or to the public; or the like).

It is clarified that the term “avatar” is used herein for demonstrative purposes, and may include any suitable type of on-screen representation, graphic representation, graphical representation, image, icon, animated image, animated icon, and/or other suitable representation (e.g., representing the sender, or the “composer” party of the animated message).

It is clarified that for demonstrative purposes, portions of the description herein may relate to a “sender” party who records a “voice-message” which is then converted into an “animated voice-message” and is then conveyed or transferred or transmitted to a “recipient” party. However, the present invention may comprise other use-cases utilizing similar operation(s); for example, some embodiments of the present invention may comprise a use-case in which a first party (e.g., a “composing party” or compose, or a content-item initiating party, or a “recording” party) generates an audio message or audio clip or audio segment (e.g., speech, singing, utterances, or the like); and the recorded audio (or captured audio) is then analyzed by the system (e.g., by a remote cloud-based server, or a remote server; or alternatively, by local analysis performed locally on the composer device, or at least partially locally at the composer device); such that a matching animation is generated and is coupled to the recorded audio (e.g., by a remote cloud-based server, or a remote server; or alternatively, by local analysis performed locally on the composer device, or at least partially locally at the composer device); and the composing user may then selectively distributed, or send, the composed animated message (having animation that matches the recorded audio and coupled thereto), to one or more selected recipients or destinations, and/or using one or more distribution methods or “content sharing” methods that are known in the art (e.g., posting to a Facebook wall or feed; posting to a LinkedIn page or feed; posting to a Twitter feed or page; uploading to YouTube; sending to recipient(s) via WhatsApp, via SMS or MMS messaging, via electronic mail, via social networks, via blogging or micro-blogging sites or applications, or the like).

Accordingly, the terms “sender” or “sender device” or “sending device” or “sending party”, as used herein, may include any party or entity or device which is used for creating or recording or capturing an initial audio segment, which is then converted or transformed by the device and/or by the system into an animated sequence, which in turn may be shared, sent and/or distributed to one or more recipient(s), destination(s), web-sites, sharing channels, distribution channels, or the like. Similarly, the terms “recipient” or “recipient device” or “recipient party” may include any such recipient(s) or destination(s) or sharing-channels or distribution-channels; and may not necessarily be limited to a single receiving device or to a specific receiving device or to a single receiving party or to a specific receiving party.

In a demonstrative implementation of voice messaging, for example, the sender may launch a dedicated voice-messaging application or “app” 111 on device 101; and may choose an avatar (e.g., an image or an icon, and/or an animated image or animated icon, representing the sender) via an avatar selector module 112. The sender may then push a button or a link or choose an option for “create/send a new message” (or, “respond” or “reply” to an incoming message, or to multiple received messages). Then, the sender may be presented with a list of the Contacts of the sender; such as, the general Contacts list stored on the device 101, or, a dedicated or application-specific Contacts list; optionally displaying the corresponding avatars or images or icons of such Contacts. The sender may utilize a recipient(s) selector module 113 to select one or more recipients from the Contacts displayed to him. In some implementations, other suitable order of operations may be used, and other suitable set of operations may be used. For example, the sender may select an avatar; the sender may then record his audio message; and may then select the platform or interface or application that would be used in order to send or transmit or share his automatically-animated message (e.g., Facebook or other social network; WhatsApp or SMS or other messaging application or service; or the like).

It is noted that optionally, device 102 may similarly comprise the same “app” 111, or a compatible application, or a general-purpose application (e.g., a Web browser) or a specific application or dedicated application able to receive and/or play-back incoming animated voice messages. In other implementations, device 102 may not necessarily comprise such “app” or application; and the animated voice-message may be presented on device 102 via other suitable way or through other suitable application or interface.

In some implementations, the recipient(s) selector module 113 may display to the sender, the corresponding avatar(s) of potential recipient(s) or contact(s), if (or: only if) such recipients or contacts have already installed the application or “app” or other module (e.g., browser extension, plug-in, add-on, stand-alone software) that enables the animated voice-messaging in accordance with the present invention; and such display of avatars of potential recipients may serve as an indication to the sender that those recipients would actually receive the animated message. In other implementations, the recipient(s) may be able to receive the animated message on any other user-selected or user-approved platform or interface, for example, through or on a social network site or application (e.g., Facebook), through or on a communications application (e.g., WhatsApp), through or on a texting/SMS application, or other suitable application or interface.

Then, the sending user may push a “record” button 114 or other suitable link or interface component, and may utter or say or sing or otherwise produce audio or voice, intended to be the audio content of the voice message, that the device 101 may record and store (e.g., locally within device 101, and/or remotely on a remote server or in a cloud computing repository) in digital format. In some implementations, a first press of the button in device 101 may start recording, and a second press of the button in device 101 may end the recording. In other implementations, a first press of the button in device 101 may start recording, and the recording may terminate automatically after a pre-defined period of time and/or a user-configurable period of time (e.g., ten seconds, twenty seconds). In other implementations, the sending user may press the button in device 101 to start recording the voice message and should keep holding or keep pressing on the button in device 101 in order to continue recording; and releasing or de-pressing the button (in device 101) may terminate the recording. In all these and/or other implementations, a microphone 115 of the device 101 may capture the voice or audio, and a recording module 116 may generate or produce a digital file 120 corresponding to the captured voice or audio, and may store it locally in a storage unit 118 within device 101 (and/or may store it remotely at a remote server or remote repository or a cloud computing server). In some implementations, audio may be recorded or captured together with video and/or images, for example, through the camera or other imaging device of device 101. In some implementations, device 101 may record and/or capture both audio and video; or only audio (e.g., to save storage space or to speed-up the audio processing). In some embodiments, both audio and video may be captured or recorded; and only the audio may be extracted and then processed. In some implementations, both the audio and the video may be utilized for processing, and/or for incorporation into the final animated voice-message that would be sent to the recipient.

It is noted that the recording module 116 may include, or may be, or may utilize, a locally-installed and locally-running audio codec or encoder or re-encoder or transcoder or compression module, which may utilize a built-in recording functionality of the sender device in order to capture audio and then to compress and/or encode and/or re-encode and/or transcode the captured audio from raw format (or from a first format) to a target format (or a second format), for further utilization or processing by the system 100. In some implementations, system 100 may be configured to ensure that the sender device 101 and/or the receiver device 102 and/or the server 103 are utilizing digital audio that is stored and/or encoded and/or compressed by using the same codec or format (and optionally, at the same or similar bit-rate, the same or similar frequency range, same mono/stereo characteristics, or the like), independently of the brand or model of end-user device(s) being used (101, 102), in order to efficiently transfer audio between the sender device 101 and the server 103, and/or between the server 103 and the recipient device 102, and in order to avoid or reduce un-necessary re-encoding or trans-coding or compression/decrompession of audio between multiple audio formats (which may, for example, require processing time and/or processing resources, may introduce latency or delays, and/or may degrade the audio quality).

In some implementations, immediately upon termination of the recording of the voice-message by the sender using device 101, the voice message may be automatically sent or transmitted or pushed (as described herein) to the device(s) of one or more designated recipient(s). In other implementations, upon termination of the recording of the voice-message by the sender using device 101, the device 101 may ask the sender to confirm or re-confirm the sending operation, or may offer to the sender to listen to the recorded voice-message prior to sending it (e.g., with an option to delete the voice-message without sending it, if the sender changes his mind), with or without also showing to the sender (on his device 101) a draft version of the matching animation sequence that is intended to be viewed by the recipient.

In the sending process of the recorded voice message, the device 101 sends or transmits or uploads (e.g., wirelessly, via a wireless transceiver 119) to server 103 the digital data representing the recorded message, for example, as a digital audio file uploaded from device 101 to server 103.

Server 103 may receive (e.g., wirelessly) the uploaded audio file 120, as well as meta-data of the audio file and/or meta-data about the sender device 101, via a wireless transceiver 121; and may store it in a database 122 or repository (e.g., within server 103, or associated with or connected to server 103, or in a “cloud computing” repository or in a “big data” repository). Database 122 may further store meta-data 123 or control data, indicating that the digital file was received from the sender who utilized device 101 and who has a particular avatar, on a particular time-date stamp, and is intended to be delivered to the recipient having device 102, and/or other meta-data 123 or control data that may assist in delivering or routing the voice-message and/or the matching animation sequence from the sender device 101 to the recipient device 102.

Optionally, an audio transcoder 124 of server 103 may transcode or re-encode the audio file 120, from a first encoding scheme or format as received from the sender, to a second encoding scheme or format that may be more suitable (optionally) for delivery to and/or playback on the recipient's device 102, and/or to a format that may be more suitable and/or more efficient for performing phoneme analysis and/or phoneme identification and/or phoneme recognition, as described herein.

A “phoneme” may be defined, for example, as a syllable; a vocal unit; a consonant; a vowel; a specific or a particular phonetic fraction of the voice; a part-of-speech or a fraction of a word that causes the mouth to move or to modify the mouth position or the mouth look; or the like. It is noted that the system may recognize, identify and/or utilize other suitable components or elements or parts of the voice or the captured audio, which may not necessarily be defined as phonemes; for example, silence period(s), noises, coughs, intonation or tones of speech (e.g., indicating excitement, questioning, doubting, thinking, or the like), indications of particular feelings (e.g., happiness, anger, sadness, disappointment, surprise, shock, or the like). Some embodiments of the present invention may utilize division of audio into phonemes; whereas other embodiments of the present invention may utilize other suitable techniques, which may be additional or alternate.

Server 103 may comprise a phoneme analyzer 125, which may receive as input the audio file (e.g., the original audio file 120; or a converted or trans-coded or re-encoded audio file, trans-coded by audio transcoder 124), and may produce an ordered list of phonemes 126 (e.g., phoneme ID, and exact time-stamps at which the phoneme starts and ends, exact in the order-of-magnitude of millisecond precision) that the phoneme analyzer 125 identifies or recognizes; the list may be stored as an XML file, or other suitable data structure or data format. A speech-to-phoneme algorithm may be used, to identify the phonemes and their corresponding time-slots (e.g., at milliseconds precision). Optionally, Microsoft Speech API (“SAPI”) may be utilized.

In a demonstrative and simplified example, in accordance with the present invention, the sender says (records, utters) the word “HELLO”. Even though the word “HELLO” comprises two syllables (HEL-LO), the system may analyze the uttered word “HELLO” and may recognize three phonemes: (a) the first phoneme corresponding to “HE”, in which the mouth of the uttering user has a first wide position; (b) the second phoneme corresponding to “LL”, in which the mouth has a narrower position and the tongue touches the upper area of the mouth; (c) the third phoneme corresponding to “0”, in which the mouth is positioned in an oval or circular position. It is noted that the above-mentioned example is only demonstrative; for example, some implementations may recognize two phonemes in the word “HELLO” (for example, “HE” and “LO”); whereas, other implementations may recognize four phonemes in the word “HELLO” (for example, “H”, “E”, “L”, and “O”); other suitable schemes or techniques or algorithms may be used to identify, recognize and/or define phonemes, or to otherwise “break” or “divide” an utterance (e.g., a spoken word or phrase) into multiple phonemes (or into other discrete units which may then be manipulated or processed). In some embodiments, optionally, after identifying and/or recognizing the phonemes, the system may recognize and/or identify the semantic meaning of specific recognized word(s) or sentences (e.g., based on dictionary file, thesaurus file, contextual analysis, natural language processing algorithm, or the like).

Furthermore, the system may measure and compute the exact timing for each phoneme, based on the exact pronunciation that the user (the sender) performed. For example, if the user said “HELLO” in a way that the last “O” is very prolonged, then, the system may recognize that the first phoneme is from 0 milliseconds to 55 milliseconds; the second phoneme is from 55 milliseconds to 94 milliseconds; and the third phoneme is actually from 94 milliseconds to 273 milliseconds (due to the longer emphasis of the “O” by the specific user). In contrast, if the user said “HELLO” in a way that the first “HE” is prolonged, then the time-slots allocated to the phonemes may be different, respectively, for example, 250 milliseconds to the first phoneme, then 40 milliseconds to the second phoneme, then 43 milliseconds to the third phoneme. In some implementations, system 100 may further recognize and/or process and/or analyze silence period(s), which may exist before and/or after and/or in-between the recognized phonemes, and/or between uttered words or uttered phrases; and the identified silence period(s) may be taken into account when the system generates or constructs animation, for example, in order to ensure smooth synchronization between mouth (or face) gestures and the audio message, and/or in order to utilize such silence period(s) in order to insert or introduce a particular animation effect and/or sound effect.

Server 103 may comprise (or may be associated with) an animation frames repository 131, which may include-for each avatar-a set of image frames that correspond to that avatar (or, to the mouth area of that avatar) in different positions that correspond to a mouth saying that phoneme; and optionally including or depicting other body-organs or face-parts which may also be animated or changed to match the phoneme(s) identified (for example, a silence period may be detected and may be matched with movement or eyes or eyebrows of the avatar, or other facial gestures or features). For example, each avatar may have a “phoneme image pack” 132 associated with it. It is noted that animation frames repository 131 and/or the “phoneme image pack 132” are shown, for demonstrative purposes, as components of server 103; however, in some implementations, animation frames repository 131 and/or the “phoneme image pack 132”, or portions of their content, may be stored locally within recipient device 102 and/or within sender device 101 (e.g., instead of storing them on server 103; or, in addition to storing them on server 103); and this may, for example, eliminate the need to transfer some or all of the animation frames from server 103 to recipient device 102. In some implementations, optionally, some or all of the animation frames may reside on a “cloud computing” server or storage, and “exchanging” or “sending” animation frames may be performed, for example, by sending a link or shortcut or pointer to the relevant file-name(s) and/or location from which the animation friends may be obtained or downloaded. Other mechanisms may be used, for storing, transferring, exchanging, sending, receiving, creating, editing, and/or updating animation frames or animation images.

It is noted that for demonstrative purposes, some portions of the discussion herein may relate to selection or generation of one (e.g., a single) animation-frame or image, per each phoneme; whereas, in some embodiments, one or more animation-frames, or one or more images, may be selected or generated to match a phoneme, or to match each phoneme, or to match each one of at least some of the phonemes.

In some embodiments, the animation may be generated by utilizing discrete layers or other discrete objects or elements. For example, a “mouth” portion of the avatar may be a discrete layer, and may be selected, displayed and/or animated by itself; additionally or alternatively, an “eyes” portion (or an “eye” portion) of the avatar may be a discrete layer, and may be selected, displayed and/or animated by itself; additionally or alternatively, a “forehead” portion of the avatar may be a discrete layer, and may be selected, displayed and/or animated by itself; additionally or alternatively, an “ears” portion of the avatar may be a discrete layer, and may be selected, displayed and/or animated by itself; additionally or alternatively, each “accessory” portion of the avatar (e.g., necklace, an earring, a hat, or the like) may be a discrete layer, and may be selected, displayed and/or animated by itself. Optionally, multiple layers may be super-imposed on each other (e.g., optionally using transparent background), or may be displayed one next to each other (e.g., animated forehead, displayed in proximity to animated mouth). This technique may allow modular and customized animation sequence(s); and/or may allow the system to generate numerous different sequences of animation based on a set of animation-frames of each such image-portion or image-region.

Server 103 may utilize a “message push module” 133 to send or “push” or transmit (e.g., wirelessly) to device 102 a notification that an animated voice-message is ready for the recipient to consume (e.g., to view and to hear). In some implementations, server 103 may automatically and/or immediately send to device 102: (a) the digital audio file of the voice message (in its original format, or in a transcoded or re-encoded format), and (b) the XML data-sets of the ordered list of phonemes, (c) the avatar of the sender, and (d) the phoneme image pack 132 that corresponds to that avatar of the sender, and optionally any other meta-data that may facilitate the communication or may assist in play-back of the animated message or that may provide to the recipient other useful data (e.g., name and/or phone number of the sender). In other implementations, these items may be sent to the recipient only after the recipient approved that he desires to receive the message. In some implementations, a brief notification may be sent to the recipient device if the recipient device is not connected to a Wi-Fi network; and the entire message may be sent to the recipient device only when the recipient device is connected to a Wi-Fi network.

On the recipient device 102, the corresponding “app” 111 may receive the data wirelessly via a wireless transceiver 155, and may utilize an animation constructor/playback module 150 to dynamically construct on-the-fly (e.g., in real time) an animation sequence, together with playback of the voice message contained in the audio file. For example, an animation constructor module 140 may playback the digital file, together with displaying the right sequence of avatar image frames that correspond to the ordered list of phonemes. In some embodiments, optionally, the voice-message may also be converted to text, using a speech-to-text converter; such that the recipient may also receive the incoming message as a text message.

The recipient may be able to perform additional operations, for example, to replay the voice-message with or without the animation; to respond immediately to the sender by composing a new voice-message; to share with friends the animated voice-message and/or to upload it to one or more social media websites or networks (e.g., using a sharing module 151); to save it for later playback; to tag it with one or more tags (e.g., using a tagging module 152); to crop or trim one or more portions of the message, and then to save or forward or share the cropped or trimmed message; or the like.

Some embodiments may comprise a software component, a software module, a set of software components or modules, an “App” or application which may be obtained or downloaded from an “app store”, a browser plug-in, a browser add-on, a browser extension, a “widget”, a desktop widget, an embedded application, a stand-alone browser having or enabling the features of the present invention, a web server or an application server having or enabling or performing or processing the features of the present invention, and ad server having or enabling the features of the present invention, or other suitable implementations.

Some portions of the discussion herein may relate, for demonstrative purposes, to creation or generation of an animation sequence (or automatic selection of animation frames) based on a phoneme-based analysis of the audio clip or voice clip. However, the present invention may utilize other suitable methods for processing audio or voice or speech, instead of or in addition to phoneme recognition. For example, some embodiments may Mel-Frequency Cepstrum (MFC) or MFC-based sound processing, utilizing a representation of the short-term power spectrum of a sound, based on a linear cosine transform of a log power spectrum on a nonlinear mel scale of frequency; utilizing Mel-frequency cepstral coefficients (MFCCs); or, “Kaldi” speech recognition or speech processing algorithms (e.g., available from Kaldi.SourceForge.net); or, the a Hidden Markov ToolKit (HTK, or HTK3) speech recognition algorithms (e.g., available at Htk.eng.cam.ac.uk); or other suitable algorithms or modules.

Some embodiments may be implemented as language-specific or region-specific or country-specific implementations. For example, an application or system implemented in the United States may utilize a U.S. English table of phonemes (or other speech recognition algorithm which may be U.S. English oriented); whereas, an application or system implemented in the United Kingdom may utilize a U.K. English table of phonemes (or other speech recognition algorithm which may be U.K. English oriented); whereas, an application or system implemented in France may utilize a French table of phonemes (or other speech recognition algorithm which may be French oriented). Other suitable mechanisms may be used to ensure or increase local compatibility with a particular language, dialect, slang, or pronunciation, the like. In some embodiments, optionally, a geo-location module may be used, in order to deduce or determine the current geo-location of the receiver device (or the sender device); and to apply to the voice-message the particular language characteristics of that device, based on the determined location. In some embodiments, the system may utilize semantic (or contextual) recognition of the spoken words, and may utilize relevant dictionary files. In some embodiments, the system may utilize and/or may comprise phonetic voice recognition modules.

Some implementations may allow the user (e.g., the sender) to edit or modify the content that he created; for example, to modify or change the avatar, to switch between or among multiple avatars, to manually edit his avatar, to import an image or a photo as a new avatar, to utilize an “avatar generator” or “avatar generating module” able to generate an avatar based on a captured image or photo or video, to select background images from a gallery or from a captured photograph or from a local file or from a remote file (e.g., which a link or hyperlink or pointer may point to), to add and/or edit sound effects, to add and/or edit background music, to add and/or edit sound filters and/or audio filters (e.g., pitch shifting, or other audio effects), to add and/or edit text or title(s) that may appear together with (or near; or on top of) the animation; to speed-up or to slow-down the voice-message and its animation; to perform editing operations (copy, cut, paste, crop, trim, or merge or combine together multiple clips or messages or audio files; or the like); to add looping effects or to loop the entire message or part of it; to apply one or more filters to the animation (e.g., slow motion, black-and-white filter, old movie filter, stereoscopic 3D filter, color modifying filter); to select and apply a modification or a “sticker” onto the avatar (e.g., selected from a pool or bank or gallery of such “stickers” or modifications or add-ons); or the like.

The system may utilize a repository of avatars and/or on-screen “stickers”, and corresponding animation frames for the set of phonemes of each avatar. Optionally, an “application store” mechanism may be used, to allow developers and/or illustrators to create their own avatars and/or animation frames and to offer them for other users for downloading, for free or for a price. Avatars and animation frame sets may be tagged, or may be categorized by subject or tagging; for example, “animals”, “children”, “fantasy”, “movie characters”, or the like; thereby allowing users to efficiently browse or search among the available avatars, based on such tags or based on textual description or keywords that may be associated with avatars (or with other elements, such as on-screen “sticker” elements or add-ons).

Some embodiments may utilize Flash technology and cut-out animation; whereas, other embodiments may utilize HTML5, JavaScript, Jquery, Jquery mobile framework, CSS, CSS3, Flash, Shockwave, Adobe Air, Unity browser, Unity plug-in or extension or add-on, “.Net” technology, any suitable native programming language, C#, Visual Studio, Java, JSON, Android Java, iOS Objective C, Canvas, Microsoft speech recognition API, SQL database, MySQL, SQL server, non-SQL database, MongoDB, compilation to an “app” using PhoneGap or other tool, PhoneGap framework, Sencha framework, audio encoding module, audio decoding module, audio trans-coding or conversion module, and/or other suitable technologies. For example, character design and animation may be provided to the client device as “sprite” sheets, that may run the animation in Canvas on the client device. Other suitable techniques may be used.

In some embodiments, each syllable may be treated as a phoneme; for example, “ba”, “ma”, “pa”, may be separate phonemes. In other embodiments, several syllable that are pronounced by using the same (or similar) gestures with the face and/or the mouth and/or the lips and/or the tongue and/or the teeth, may be grouped to correspond to one single phoneme; for example, the above-mentioned syllables (ba, ma, pa) may be treated as the same single phoneme.

Some embodiments may utilize phoneme recognition/analysis, and the matching of a phoneme to a pre-drawn image or animation frame, instead of the manual and effort-consuming lip sync process that human animators perform when they create an animation from scratch.

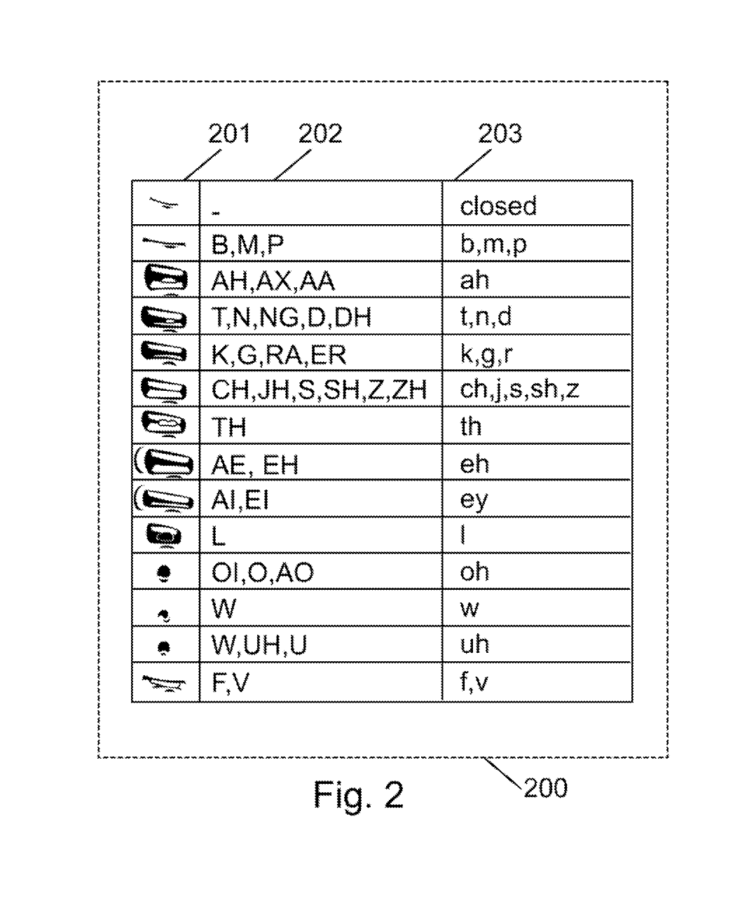

Reference is made to FIG. 2, which is a table 200 demonstrating an image frame of a mouth of an avatar, corresponding to various phonemes that may be identified or recognized in the recorded voice-message, in accordance with some demonstrative embodiments of the present invention. Table 200 may be utilized as a lookup table, that the server or the sender device or the recipient device may utilize, in order to match between a phoneme and its respective image or frame. In table 200, each row may correspond to a phoneme. In table 200, the first column 201 may indicate a frame or image that corresponds to that phoneme; the second column 202 may indicate a brief textual name for the phoneme; and the third column 203 may indicate one or more sounds that are typically associated with that phoneme. Other suitable lookup tables may be constructed and utilized.

Other suitable phoneme recognition schemes, or phoneme-to-animation-frame tables or lookup tables, may be used; for example, utilizing the list of phonemes that is enclosed further herein, or utilizing other suitable tables or schemes, or by using other techniques which may not necessarily require a table or a lookup table.

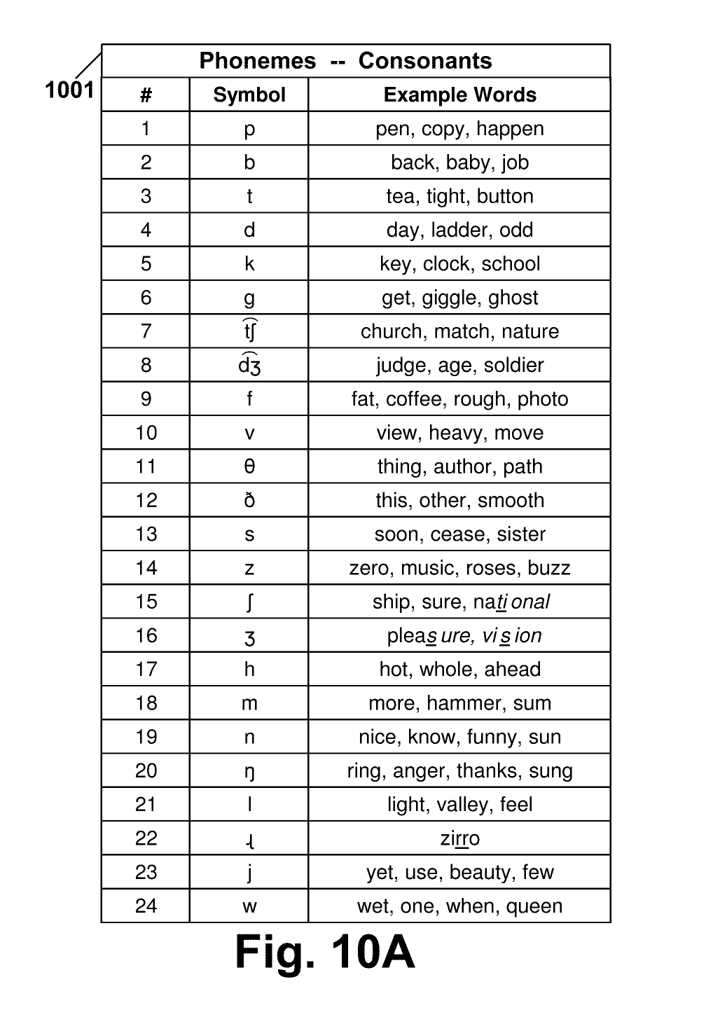

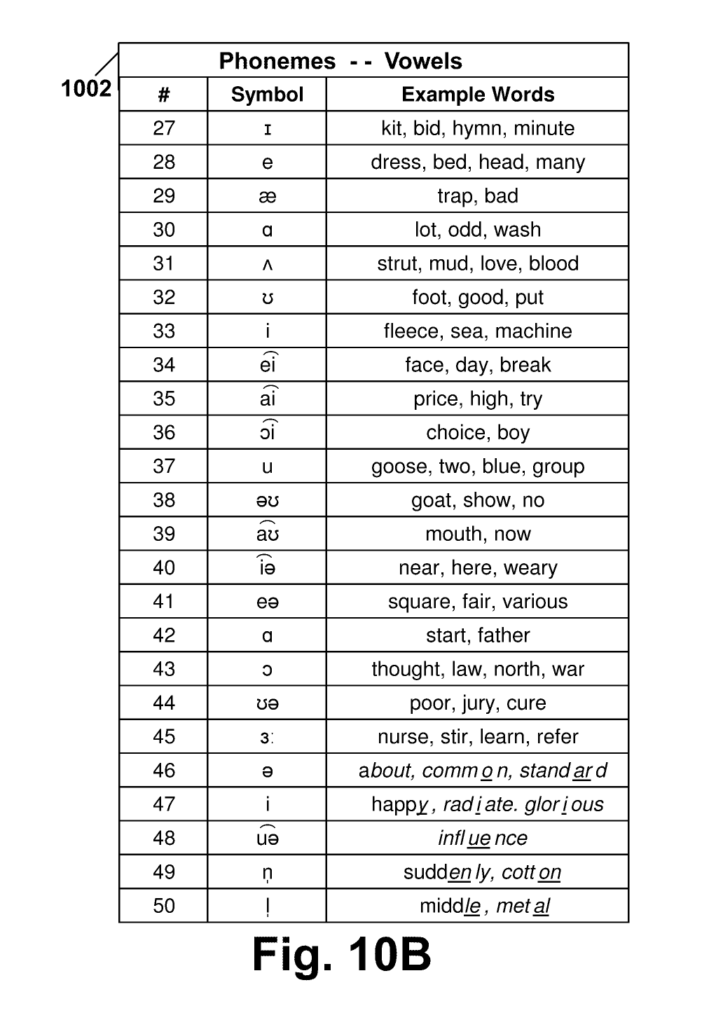

Reference is also made to FIG. 10A, which is a table 1001 demonstrating phonemes that correspond to consonants, in accordance with some demonstrative embodiments of the present invention; as well as to FIG. 10B, which is a table 1002 demonstrating phonemes that correspond to vowels, in accordance with some demonstrative embodiments of the present invention. Tables 1001-1002, or similar or other lookup tables, may be utilized in order to recognize, identify and/or determine the division or the conversion of uttered speech (or captured audio) into phonemes.

Although portions of the discussion herein may relate, for demonstrative purposes, to animation of the mouth or the mouth area based on identified phonemes, the present invention may comprise and/or may utilize animation and/or modification of images of other facial parts or body parts, together with the mouth or instead of it. For example, the animation constructor module may cause the animated avatar to raise his eyebrows, to move his ears or nose, to blink or close his eye(s), or to animate other body regions or face regions. Optionally, such animations may be triggered by a particular speech recognition (e.g., identifying that the sender said “wow” or “yo!” may cause the animated avatar to raise his eyebrows), or by a particular length of silence in the voice message (e.g., a silence period of one second may trigger a blinking of both eyes of the animated avatar), or may be performed in particular time intervals (e.g., blinking of eyes every four seconds) or at pseudo-random time intervals (e.g., every 3 or 4 or 5 seconds, selected pseudo-randomly). In some embodiments, the system may allow the sender to utilize his device 101 in order to review and edit a draft of the animation sequence, and may allow the sender to pro-actively insert or add such animation effects at desired locations in the animation sequence.

The present invention may support, also, particular type of messaging for a particular purpose; for example, enabling a user to compose an animated voice-message to congratulate a friend for a happy occasion, or to wish a happy holiday, or to convey a romantic message or a comic message or a sad message, or to advertise a product or service, or the like. For example, the user (the sender) may indicate that he intends to record and send a romantic voice-message, and the system may automatically choose or suggest a suitable background image, and/or a suitable background music, and/or may add a flower or a ribbon or a heart to (or near) the user's avatar, or the like, based on the “theme” (or a use-selected “genre” or type) of the voice message that the sender intends to send.

The system may be built to scale, and may support thousands or millions of users and/or messages. For example, voice-messages may be stored in a “cloud” repository or other “big data” repository; and phoneme analysis and animation construction may be performed in a “cloud computing” server or group of servers.

In some embodiments, the avatar animation may be based on Canvas technology; for example, the HTML5 Canvas element may be used to draw graphics, on the fly, via scripting. This may be a fully compatible and light-weight replacement, instead of Flash technology. All characters may be drawn from a pre-formatted sprite sheet. The animation may support the use of potentially unlimited number of characters. Animation may be created dynamically using phoneme data (e.g., using XML/JSON/other format) and will sync to the audio file, dropping frames in necessary places if needed in order to keep the lip syncing as prefect as possible. In some implementations, the app may support unlimited number of character or avatars; for example, by storing the avatar animation frames on the server (and downloading them to the client device on need-to basis, to enable a particular animation of a particular avatar).

In some embodiments, the server-side application may utilize C# and/or “.net” technology, and may be compatible with Windows/IIS servers. Microsoft speech library may be used for analyzing sound files. The system may perform “real time” analysis (processing a sound file takes the amount of time required to play it), or may use other solutions to increase the speed or efficiency of audio analysis. All message data files may be saved on the server. The server may support multiple concurrent users, and may handle or balance traffic load; and optionally may use various techniques (e.g., “cleans service”, client full-receive confirmation).

In some embodiments, the system and/or its devices may enable user(s) to conduct one or more Chat sessions; for example, one-to-one chat session between two users; and/or one-to-many or many-to-many chat sessions (e.g., a chat among a group of users who are members of a chat group). The chat sessions may comprise textual chat, audio chat, video chat, and/or utilization of animated audio messages which may be exchanged among the chatting user(s) as part of the chat, as integral part of the chat session, or as an add-on or external feature which may accompany the chat session. In some embodiments, an animated audio message may be sent and/or received as a stand-alone item, or as a playable item, as integral part of a chat session. In other embodiments, an animated audio message may be linked from a chat session, or may be referred-to by a chat session; for example by automatically including in a chat session a link or hyperlink or shortcut or code-portion or pointer that causes the other user(s) or the recipient(s) to trigger play-back of an animated content item, which may be stored in a remote server or in a cloud-computer server, or which may be partially or entirely downloaded to the end-user device(s) of such recipient(s) and/or chat user(s). Other suitable methods may be used.

In some embodiments, the system and/or its devices may enable user(s) to conduct one or more Video Conference sessions; for example, one-to-one video conference session between two users; and/or one-to-many or many-to-many video-conference sessions (e.g., a video conference session among a group of users who may optionally be members of a group, or which may invite each other to join such video-conference session). The video-conference sessions may optionally comprise video-conference among users by way of sending and/or receiving and/or exchanging the animated audio messages among such users; and may optionally further enable to the users of the video-conference session to exchange among them textual content, audio content, video content, and/or the animated audio messages which may be generated in accordance with the present invention; and all these, or some of them, may optionally be part of the video conference session, as integral part of the video conference session, or as an add-on or external feature which may accompany such video conference session. In some embodiments, an animated audio message may be sent and/or received as a stand-alone item, or as a playable item, as integral part of a video conference session. In other embodiments, an animated audio message may be linked from a video conference session, or may be referred-to by a video conference session; for example by automatically including in a video conference session a link or hyperlink or shortcut or code-portion or pointer that causes the other user(s) or the recipient(s) to trigger play-back of an animated content item, which may be stored in a remote server or in a cloud-computer server, or which may be partially or entirely downloaded to the end-user device(s) of such recipient(s) and/or video conference user(s). In some embodiments, the exchanging of automatically-generated animated audio messages, may enable a user of a mobile device that does not conventionally support a video conference (e.g., an Apple Watch, or some other types of wearable devices of smart-watch devices) to actively participate in a video conference session, or in an animation-based video-conference session. Some embodiments may enable real-time exchanging, or substantially real-time exchanging, or partially-real-time exchanging, or semi-real-time exchanging, of automatically-generated animated audio messages, among a pair of users or among a group of users; and optionally, even via an electronic device that does not necessarily support (or, does not natively support) video playback. In some embodiments, the exchanging of automatically-generated animated audio messages, may enable a user to participate anonymously and/or partially-anonymously in an animation-based video-conference session which may be privacy-oriented or may provide privacy and/or anonymity or at least partial-privacy and/or partial anonymity; such that, instead of seeing the real-life face of the user, the other user(s) may see his animated avatar, accompanied by his audio voice (or alternatively, accompanied by a converted or replaced audio segment in which the user's real-life voice is converted into another voice in order to further preserve the anonymity or privacy of the use). Other suitable methods may be used.

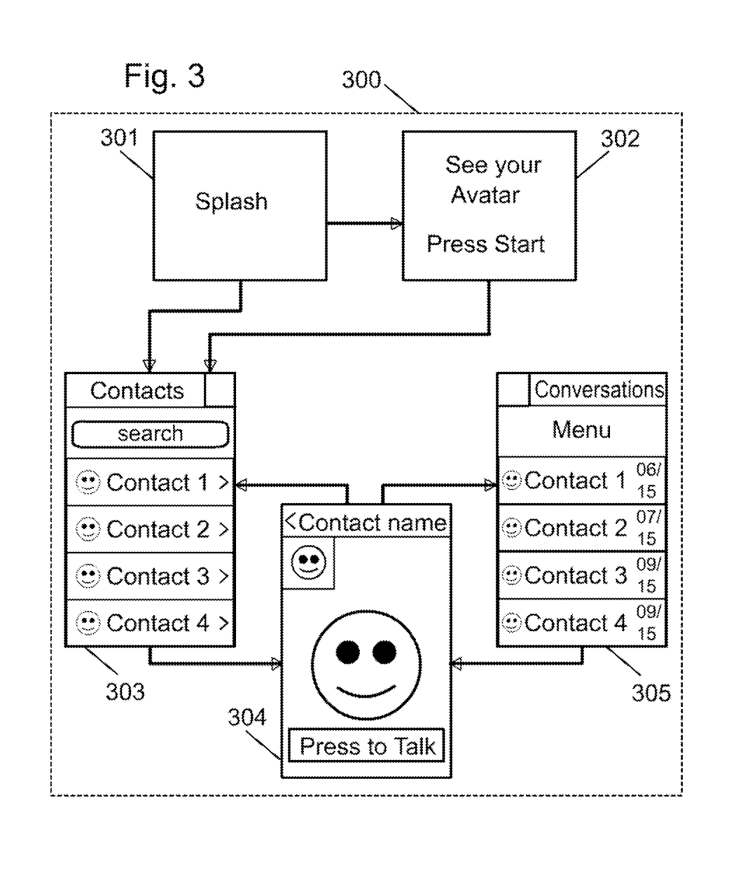

Reference is made to FIG. 3, which is a schematic illustration demonstrating an “app” wireframe 300, in accordance with a demonstrative example of an implementation of the present invention. Wireframe 300 may comprise, for example, five demonstrative screens 301-305.

Screen 301 may be a Splash screen, which displays while the application is loading or launching.

Screen 302 may be a “This is You” screen: The user selects or creates or sees his own Avatar (each user gets a dedicated avatar); and optionally showing a “start” button. In some implementations, this screen 302 may be shown to the user only one time, for example, after the first launch of the application. In some implementations, the user may be able to subsequently access again the screen 302 in order to modify or edit or change or delete his/her initial choice(s).

Screen 303 may show Contacts, showing a view of the list of contacts that the user has on the device (or contacts that are associated with the device or with the user account, such contacts may be stored locally in the device and/or remotely on a remote server); and further showing a search box (or other search or browsing interface components) to search or browse for a specific contact. Pressing on a contact that has already joined the “app” or service of the present invention, leads to a possibility to send him a voice message that will be animated. Pressing on a contact that has not yet joined the “app” or service of the present invention, may trigger an option to send an invitation to join, to such contact; and optionally, may store the animated voice-message until the recipient indeed joins the “app” or service, and then the recipient may receive the waiting or queued animated messages that were sent to him even before he joined the service or “app”.

Screen 304 may enable message recording and sending: View of the sender's avatar in a small frame; View of the friend (recipient) avatar in big frame; Name of friend at the top; a “go back” button. In some embodiments, pressing on the button of “press to talk” will start recording. Release of the button (or, re-pressing it) will cause a “send” (wireless upload) of the audio recording to the server. Optionally, the app may enforce a maximum length of the recording (e.g., seven or ten seconds).

Screen 305 may comprise Conversation(s), and may show the talk bubbles of the messages, namely, everything the user sends will be visible to himself, saved on the client device (and/or on a remote server) for showing, and optionally for further sharing to social networks and email and/or to other recipients. The order of messages will be linear based on time sent and received; with an option to sort/filter by contacts, by groups, by date-range, based on “favorites” (e.g., if the user has marked or tagged particular messages and/or particular contacts as “favorite” or “star” or “preferred”) or the like.

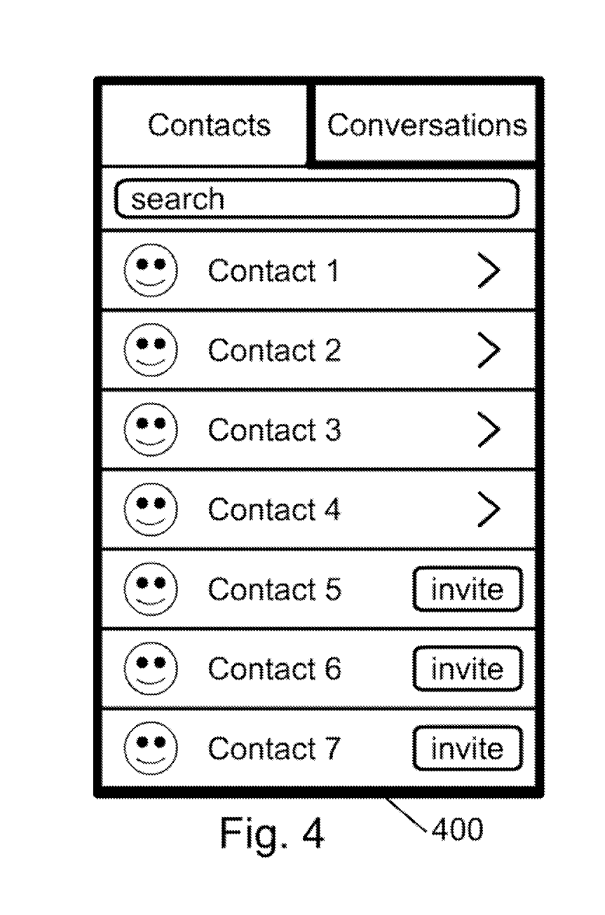

Reference is made to FIG. 4, which is a schematic illustration of a Contacts screen 400, in accordance with some demonstrative embodiments of the present invention. Optionally, the list of contacts may be sorted or arranged such that, for example, the firstly-displayed contacts (at the top) indicate the contacts of the user who have already joined the service or the application of the present invention, and those users may be immediately and readily available for engagement; and then, the list may continue by displaying (at the bottom) the contacts that have not yet joined the application or the service and that may require to be “invited” (and may need to actively “accept” such invitation) in order to engage with the service of the present invention.

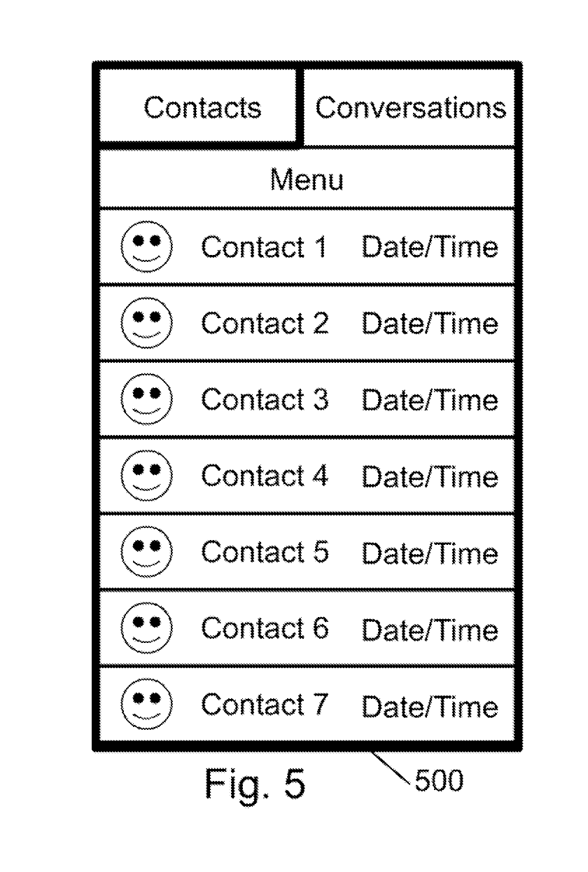

Reference is made to FIG. 5, which is a schematic illustration of a Conversations screen 500, in accordance with some demonstrative embodiments of the present invention. Conversations may be sorted based on contact name, based on time/date in which the most-recent communication took place, based on a user-selected order (e.g., listing on top one or more particular users that the user prefers to see at the top), or the like. Optionally, conversations that contain content or animated sequences that were not yet watched or consumed by the user, may be shown together with a suitable indication or mark.

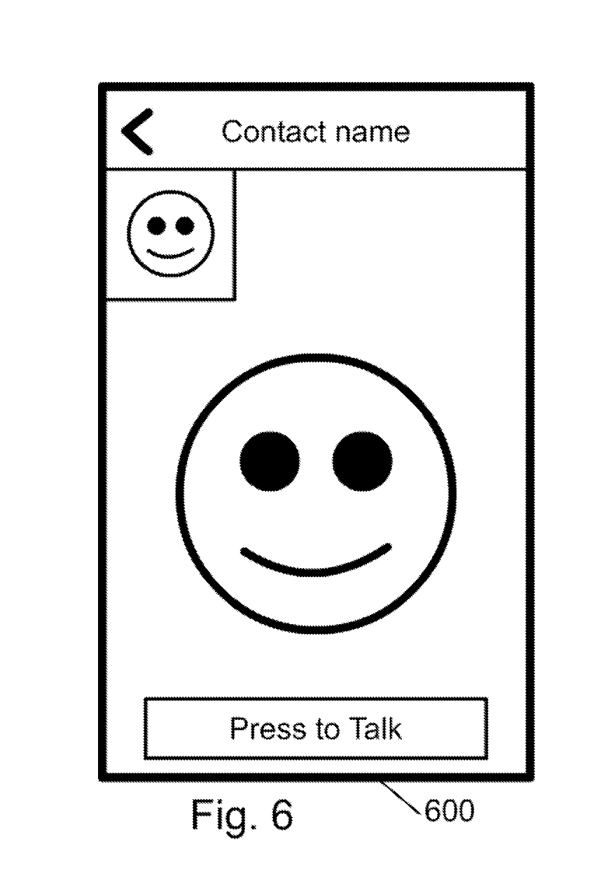

Reference is made to FIG. 6, which is a schematic illustration of a Compose Message screen 600, in accordance with some demonstrative embodiments of the present invention. Screen 600 may comprise the user interface components enabling the sending user to write text and to capture audio. The system may then generate and add the matching animated sequence for the user's content.

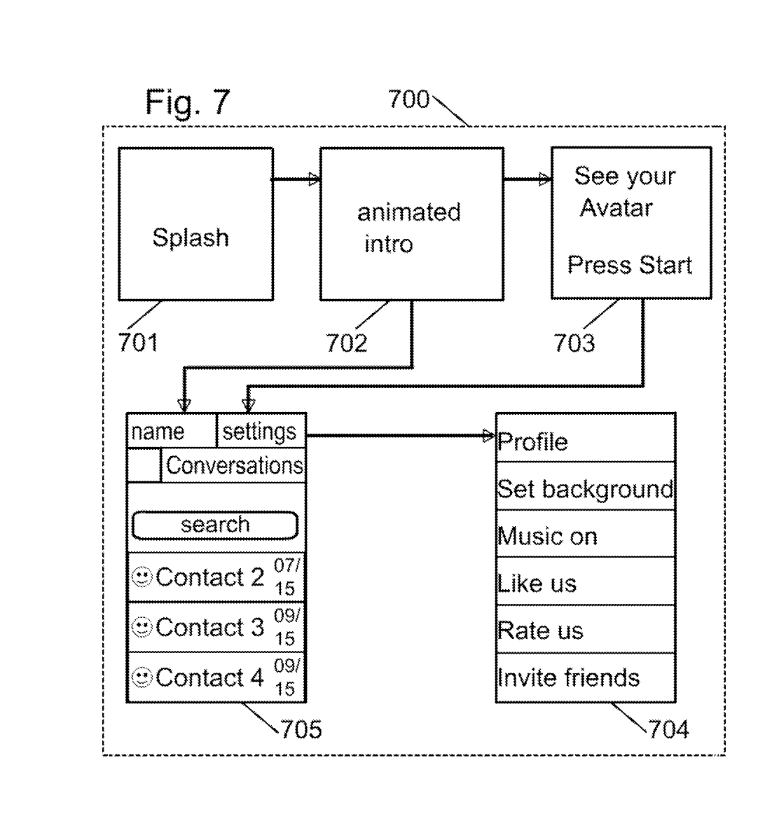

Reference is made to FIG. 7, which is a schematic illustration of a wireframe flow 700 of screens 701-705, in accordance with other demonstrative embodiments of the present invention. For example, a Splash screen 701 may be followed by an animation introduction screen 702; a particular first-entry (first usage, first launch) screen 703 may be shown only upon a first usage of the application by a new user, optionally associated with a Settings/Configuration screen 704 or step-by-step “wizard” module; whereas the Conversations screen 705 may be displayed to a non-new user, namely, to a user upon his second or subsequent entry or launch of the application. Other suitable screens or flows may be used.

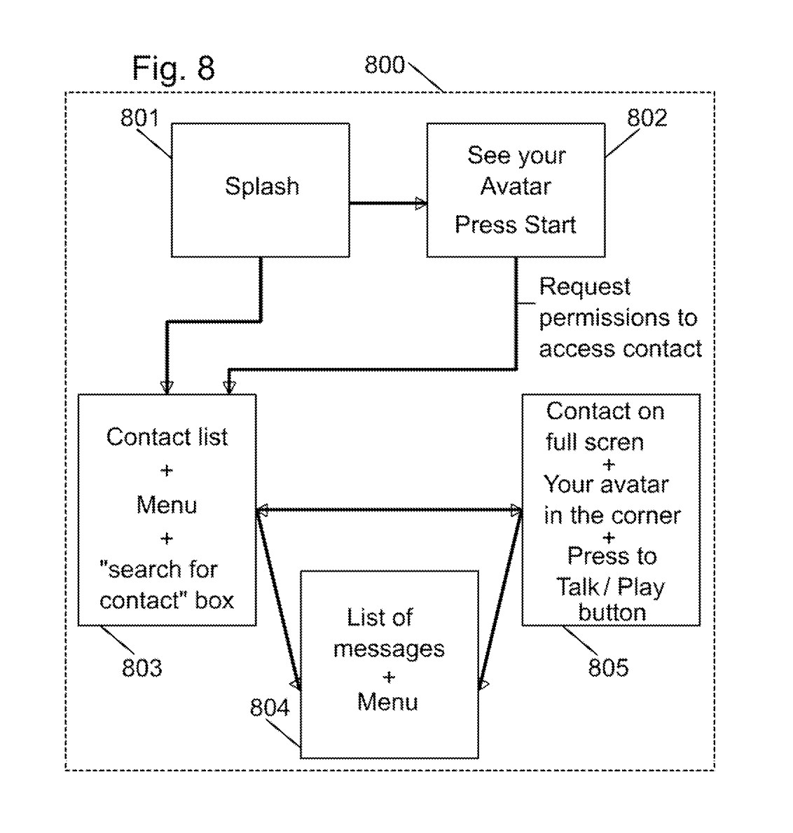

Reference is made to FIG. 8, which is a schematic illustration of a wireframe flow 800 of screens 801-805, in accordance with some other demonstrative embodiments of the present invention.

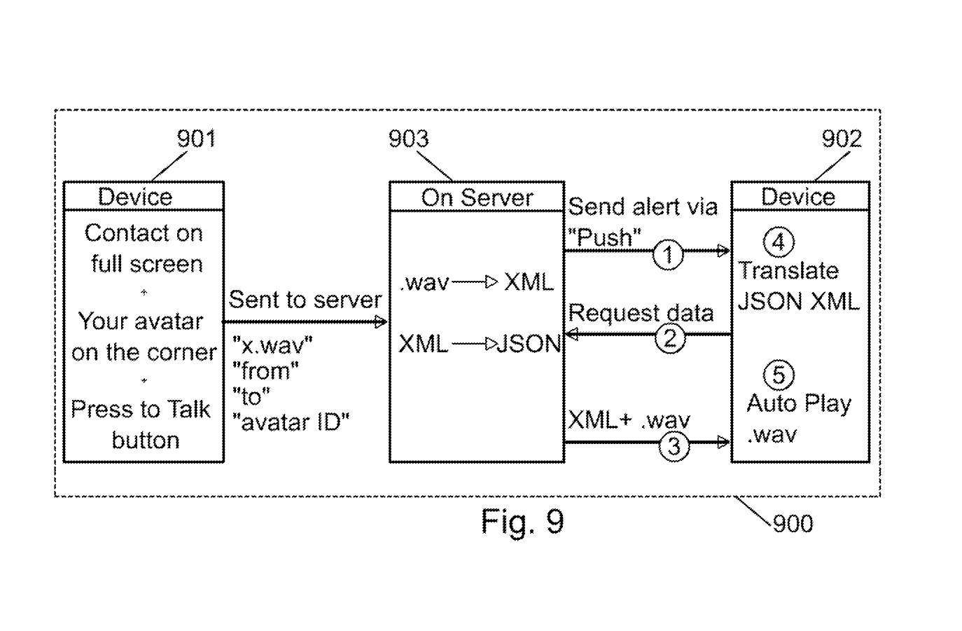

Reference is made to FIG. 9, which is a schematic illustration of a system 900 demonstrating a demonstrative flow, in accordance with some embodiments of the present invention. System 900 may comprise a sender device 901 and a recipient device 902, as well as a server 903 which may facilitate the communications between them and may further perform the processing operations therein. Further demonstrated are the steps of the flow of communications among these components of system 900. Sender device 901 may allow the sender to capture audio, and may then send the captured audio to the server 903. Server 903 may perform the analysis of the captured audio, the generation of a phonemes list or sequence, and the generation of a matching sequence of animation frames. Server 903 may then send to the recipient device 902 data representing the audio and the animation sequence, which the recipient device 902 may then present to the recipient in synchronization between the audio and the animation.

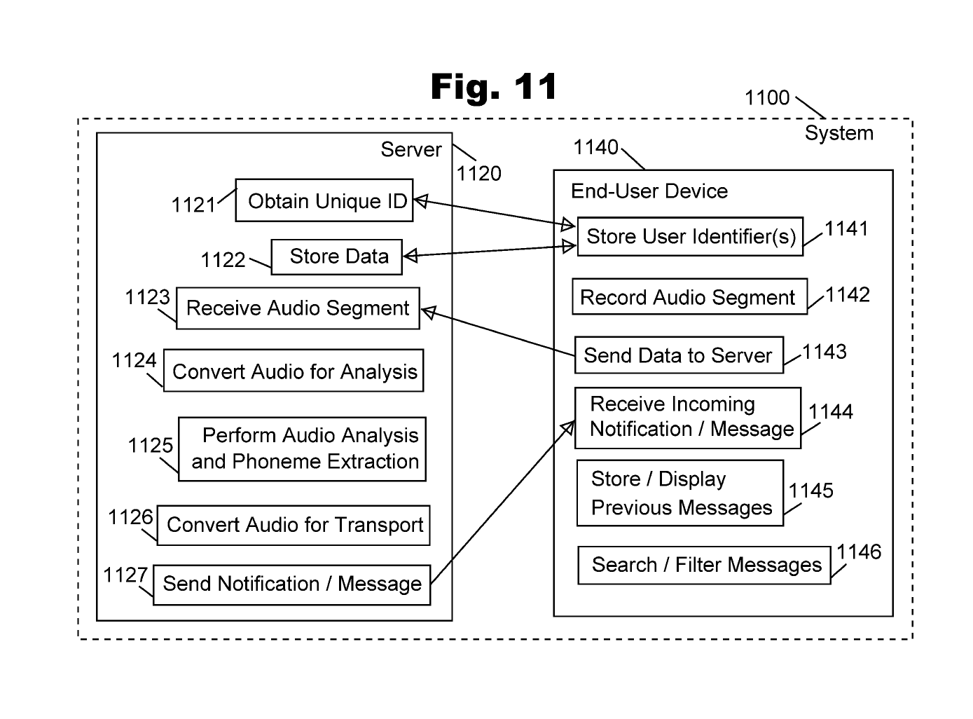

Reference is made to FIG. 11, which is a schematic block-diagram illustration of interactions in a client/server system 1100, in accordance with some demonstrative embodiments of the present invention. System 1100 may comprise a server 1120 able to communicate with an end-user device 1140. For example, server 1120 may be a Microsoft Windows server, able to run code using a dot-net (“.Net”) framework and/or as web-based application(s) and/or as native applications. End-user device 1140 may be, for example, a smartwatch or tablet or smart-watch or other electronic device; which may run a native application or “app”, or a web-based application, or an application developed with PhoneGap and/or with HTML5 and/or with Canvas. Other suitable modules or programming elements may be used.

End-user device 1140 may store indications or identifiers of other registered users or “contacts”; as well as user-initiated additions of such Contacts list (box 1141). End-user device 1140 may allow recording of an audio segment (box 1142), for example, using a plug-in or using the application running on the end-user device 1140. End-user device 1140 may send to server one or more data-items (box 1143), for example: the audio segment (e.g., represented as 3GP or as WAV file); username; password; unique identification number (UID) in order to establish client/server communication channel for notifications; and optionally, a phone number associated with the end-user device 1140 operating as a composing (or sending) device; and optionally, a phone number or other destination identifier that is associated with one or more intended recipients.

End-user device 1140 may further allow reception of incoming animated message, or reception of an incoming notification that an animated content-item is ready for downloading and/or for playing (box 1144). End-user device 1140 may further allow storing and displaying of previously-received and/or previously-composed animated messages (box 1145), with indications of whether or not each animation was already viewed at least once. Optionally, end-user device 1140 may further allow searching or filtering of such animated messages (box 1146), based on one or more criteria (e.g., time length of message; freshness of message; sender identity).

Server 1120 may generate or may request (e.g., from iOS iCloud/APN, or from Android GCM) a unique identifier for the application for a specific end-use device (box 1121); and may store user data in a database (box 1122), for example, phone number, operating system, avatar, and unique identifier of each end-user device for purposes of Push notifications. Server 1120 may receive and store the incoming recorded audio segment (box 1123); for example, storing it in the database together with meta-data (e.g., time-date stamp; phone number of the sending user; phone number of intended recipient user(s), or the like). Optionally, server 1120 may convert or trans-code the audio segment (box 1124), from the format of the incoming audio segment, to other format which may be more suitable for further analysis (e.g., to WAV format). Server 1120 may perform audio analysis for phoneme extraction/identification (box 1125); may identify words and/or phonemes and/or syllables and/or other discrete units; may optionally translate or convert the words or sounds in a phonetic manner; may perform correction of words or identified units; and may export to XML and convert to JSON. Optionally, server 1120 may perform conversion or trans-coding of the audio segment into another format (e.g., MP3) which may be more suitable for transporting the audio segment to the recipient device(s) (box 1126). Then, server 1120 may send a notification to the recipient end-user device (box 1127); for example, via the Android Google Cloud Messaging (GCM)/Apple Push Notification (APN); for example, sending a JSON string that describes the phonemes and their sequence/order and their timing scheme, as well as the audio segment (e.g., as MP3 file).

Other suitable modules or operations may be used; and furthermore, operations that are described as performed on the server, may actually be performed on the end-user device, or vice versa.

Some embodiments of the invention may be used in conjunction with, or may be integrated with or embedded with, an Augmented Reality (AR) device or article or glasses or portable item or helmet or hat or headset or microphone; for example, a Google Glass device or a similar device, or a device or system having similar capabilities; or with a watch or smart-watch device (e.g., Samsung Galaxy Gear) or an Apple Watch device or other “iWatch” device or smart-watch device or wearable device or a personal fitness band or device; or by integrating features of the present invention into a web-browser, a browser plug-in or browser extension or browser add-on, a dedicated software, or the like; as well as other suitable devices or systems, for example, a chat system, a video conference system, a an interactive kiosk for communications, or the like. The present invention may be utilized for a variety of other purposes, for example, by utilizing an API and/or and SDK that may enable third-party developers to utilize the modules of the present invention in order to efficiently achieve or deploy other implementations.

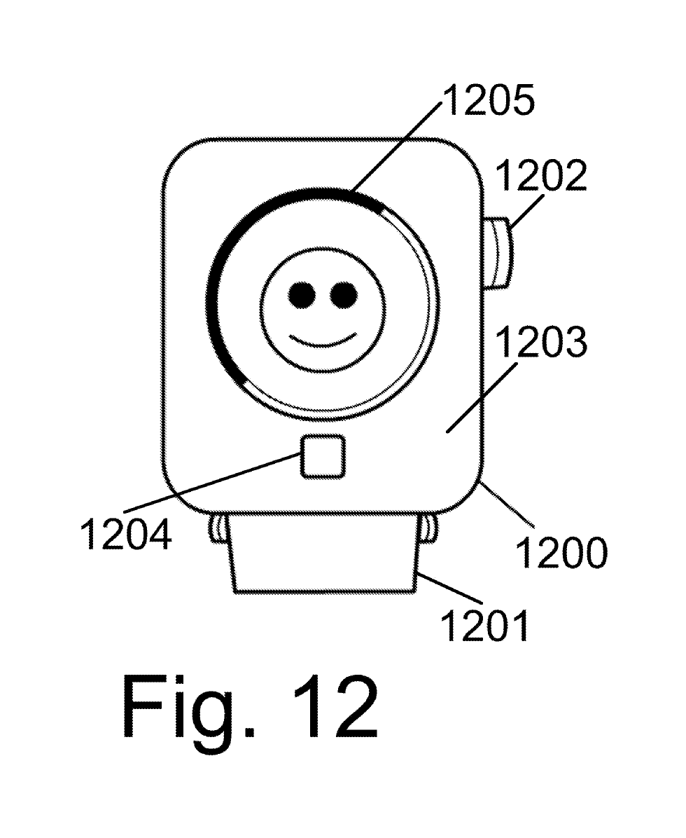

Reference is made to FIG. 12, which is a schematic illustration of a smart-watch 1200 in accordance with some demonstrative embodiments of the present invention. Smart-watch 1200 may comprise, or may be associated with, a strap 1201 (e.g., for wearing the smart-watch 1200 around the wrist); and may comprise one or more physical button 1202 which may be pressed and de-pressed, as well as a touch-screen 1203. Smart-watch 1200 may run code which enables the user to receive and play-back incoming animated messages, displayed on the touch-screen 1203, in synchronization with audio played-back by speaker(s) of the smart-watch 1200. In a demonstrative display, touch-screen 1203 may show an avatar (e.g., shown as a smiley face in FIG. 12). One or more User Interface (UI) elements 1204 may further be displayed, for example, a generally-square “stop” button which may trigger stopping a played-back animation, or may trigger stopping of a recording of new audio segment. Optionally, a graphical indication 1205 which may be (for example) circular, may further be displayed in order to visually indicate the elapsed time and/or the remaining time; for example, the dark portion of graphical indication 1205 may indicate elapsed time, whereas the bright portion of graphical indication 1205 may indicate remaining time (e.g., for recording, for play-back, or the like). Other suitable representations may be used.

Some embodiments of the invention may be integrated in a telephone system or telephone network, by a telephone service operator or provider, or by a cellular service provider or operator; or in a voice-messaging system operated by a network operator or telephone carrier, or by an organizational or enterprise voice-messaging system. Optionally, the features of the present invention may be provided to all users, for free or for a price; or may be provided only to “premium” users for a fee. In one implementation, for example, every voice message in an organization or an enterprise or company, or at a voice message system of a telephone carrier or a cellular service provide, or at a chat-service or video-messaging service, may automatically be analyzed such that phoneme-based animation may be created for it and associated with it; and such that the recipient of any incoming voice-message may optionally view the associated animation, in synchronization and lip-sync with listening to the audio message itself. This may be implemented as an integral feature of a telephonic or cellular voice-messaging system, without necessarily requiring any dedicated application or “app” to be installed and/or operated on the sender's device and/or the recipient's device.

Some embodiments may optionally comprise modules or tools for automatic generation or creation of animation sequence(s) (e.g., 2D animation, 3D animation, stop-motion, cutout), based on content provided and/or selected and/or edited by the user, and in accordance with user decisions. In some embodiments, a step-by-step “wizard” module or tool may be utilized to assist the user in composing or generating such animated sequences.

In some embodiments, the system may optionally comprise an Application Programming Interface (API) to allow inter-connection or integration with other applications or systems; for example, allowing animated characters to be inserted into, or overlaid on, a movie clip or a streaming movie or a movie file, Augmented Reality scenes or objects or views, images, photographs, animations, Internet websites, games or gaming consoles, or the like; and to enable the utilization of animated talking avatars in such systems, as well as chat or messaging among users of such systems.

In some embodiments, the system may automatically insert animation corresponding to face gestures or body gestures, of the suitable avatar, based on pre-defined rules. Some demonstrative examples may include, for example: (a) Causing the eyes of the avatar to blink, at the beginning of a sentence, or at the end of a sentence, or at pre-defined intervals (e.g., every three seconds), or when identifying a silence period of a particular length (e.g., at least one second); (b) Causing the pupils or eyes of the avatars to move or to change their characteristics, based on pre-defined rules, for example, causing the pupils to move sideways if a particular phoneme or word is identified (e.g., “hmmm”), or causing the pupils to look up if a particular phoneme or word is identified (e.g., “ah”); (c) causing other pupil effects, such as indicating surprise if an “exclamation mark” sentence is detected, or indicating questioning if a question is detected; (d) causing other animated effects based on identification of particular words that were uttered in the audio message, for example, generating an animation of explosion of the user said “bomb” or “amazing”, generating an animation of Confetti if the user said “party” or “celebrate”, generating an animation of a smile if the user said “OK” or “alright”. In some embodiments, the user may generate or edit or modify one or more rules for such added animations or effects; for example, in some embodiments, the user (or the sender user, or the recipient user, or the server, or the sender device, or the recipient device) may define a rule that every time that the word “wow” is identified in the audio message, a raising of two eyebrows should be displayed in the animation sequence. In some embodiments, a list of pre-defined optional animation effects may be presented to the user, who may selectively activate or deactivate each animation effect.

Some embodiments may perform contextual analysis to identify words and meaning within the uttered voice message, and to generate and display marketing materials or ads accordingly; optionally by taking into account location-based information of the user's device (e.g., obtained via GPS or Wi-Fi or cellular triangulation). For example, if the user's voice message comprises “do you want to have lunch with me?”, then, obtaining a list of nearby restaurants and presenting to the user (the sender and/or the recipient) one or more data items from such list, optionally presenting also a coupon or promotion code for utilization at such restaurant (e.g., as a barcode or QR code, and optionally by utilizing geo-location or the nearest such restaurant in order to provide to the user data about its location).

Some embodiments may utilize preset or pre-defined animation sequences, of a particular avatar or character, based on the user selection; for example, allowing the user to select a mood or emotional state (e.g., happy, sad, angry, surprised, excited, bored, tired) and/or an action (e.g., jumping, travelling), and then presenting such present animation in conjunction with playback of the user voice message and/or in conjunction with background image or background animation that the user selects (e.g., driving, travelling, diving, resting, eating, drinking).

Some embodiments may determine or estimate the mood or emotional state of the user, based on contextual analysis of text that the user uttered (e.g., using a speech-to-text converter), or using tone analysis of the audio; and may generate images or animation(s) that correspond to such mood or emotional state, or may modify the avatar's mouth or face or body features or facial gestures or body gestures based on such identified mood or emotional state. In some embodiments, an Emotion Estimation Module (or plug-in, or SDK/Software Development Kit) may be used in order to identify and/or estimate emotion(s) or mood(s) that are associated with the uttered audio segment; such that the animation sequence may reflect (or may include animation effects that reflect) such identified mood or emotions. In some embodiments, a speech-to-text converter may be used, and textual analysis or contextual analysis may be performed, in order to identify or estimate such emotions or moods.

Some embodiments may utilize a tone converter or a voice converter, in order to convert or modify or transform the user's original voice into a voice of another person or another character (e.g., voice similar to the voice of a famous singer or actor or celebrity; voice of a cartoon character; voice of a baby; voice of a female or a male; or the like). The converted audio may be played-back in conjunction with synchronized animation of the avatar.

Some embodiments may capture movements or motion or gestures performed by the user (e.g., via camera, motion sensors, accelerators, accelerometers, gyroscopes, or other sensors), and may generate animation or may modify animation by taking into account such user gestures or motion or movement.

Some embodiments may utilize a speech-to-text converter module, to convert the captured audio or uttered voice message into text, and to present the text of the message together with the animated avatar. The system may allow exporting and/or saving of the extracted text of such messages. Optionally, the sender and/or recipient may exchange text messages, in addition to exchanging voice messages. Optionally, such messaging features (of voice, animation, text) may be enabled among two or more users, or among a group of users.

Some embodiments may allow to produce, export, save and/or share a “conversation movie” or “conversation clip”, comprising one or more animation sequences and their corresponding voice messages (and optionally, text content or text messaging, if relevant), as well as publishing or sharing of such movies or items via one or more methods (e.g., a stand-alone movie file; a hyperlink or shortcut to a playable movie clip; an email attachment; a messaging application attachment; uploading to a social network or to other target websites; automatic conversion to other formats which may be shared or sent or displayed or played-back, such as an Animated GIF sequence, or a Vine clip, or the like).

Some embodiments may further enable the following features, to all users or only to “premium” users (e.g., for a fee); for example: (a) replace the user's avatar, with a premium avatar that may be selected or purchased from a repository of premium avatars; (b) user-construction of an avatar based on a repository of face-parts or body-parts or other elements and accessories (e.g., sunglasses, hat, earrings; and optionally featuring branding or sponsorship for such accessories or add-ons, for example, a scarf showing the name or logo of a fashion retailer or of a soccer team); (c) capture the user's face, and automatically and/or manually generate an avatar that resembles the user's face or that is more tailored to the user's real appearance (e.g., skin color, earrings, hat, sunglasses, makeup, tattoo); (d) automatic and/or manual editing of the recorded voice message (e.g., cut-and-paste of audio portions; merging or appending multiple portions together; removing long silence periods; filtering-out noises or background noises; (e) editing and/or combining of multiple “conversation movies”, as well as applying filters to such movies (e.g., old movie filter; “eighties clip” filter; stereoscopic/3D filter); (f) applying filters to the recorded voice message (e.g., make it faster or slower; change the pitch or tone; remove noises; improve quality); (g) change the background image, from a repository of background images, or from images or movies captures by the end-user device, or by downloading background image(s) from the Internet; (h) adding or inserting of text or title(s), in a user-selected font type, font size, font color; (i) adding background music and/or sound effects (e.g., explosion, trumpet) from a repository, from items stored on the end-user device, or by downloading such items from the Internet.

In some embodiments, some or all of the operations that are described above, may be performed on a server computer or in a cloud-computing server or element. In other embodiments, some or all of the operations that are described above, may be performed on the electronic device operated by the user who composes or utters the audio segment (e.g., smartphone, cellular phone, tablet, smart-watch, laptop computer, desktop computer, wearable electronic device, portable electronic device, gaming device, Augmented Reality (AR) device, smart television, smart TV, or the like). In still other embodiments, some operations may be performed remotely on the server computer or the cloud-computing server; whereas other operations may be performed locally on the electronic device of the “sender” or the “composer” user. In still other embodiments, some operations may be delegated to be performed locally on a content-consumption device, or on the electronic device of the recipient(s) of the animated sequence; for example, if such recipient device(s) receive an XML file and a set of images and re-build locally the animation sequence in the recipient's device. Other suitable architectures may be used.

Some embodiments may comprise, or may be associate with, an SDK or API or other module(s) which may facilitate the utilization of the present invention by particular users or developers or systems; for example, by programmers or designers, by marketing personnel, by pedagogic or education team-members, or by other particular industries.

Some embodiments may allow a user to manipulate avatars, to import or export avatars, to customize avatars, to edit or modify avatars, to accessorize avatars, to “celebritize” avatars (e.g., modify them to be similar to a celebrity or famous person or famous character), to purchase premium avatars, or the like.

Some embodiments may allow the user to add, edit, modify, select, purchase and/or replace: sound effects, animation effects, visual filters, animation filters, background music, and/or other modifiable or replaceable elements of the animation sequence being generated.

Some embodiments of the present invention may utilize a flow or method of operations, which may utilize multiple screens or tabs, for example: (1) a first login/first launch screen; (2) an Avatars Selection screen; (3) a chat screen; (4) a Contacts screen; (5) a Settings screen.

In the First log-in/first launch screen or tab, for example: (1.1) At launch, show link to terms and conditions and click continue; (1.2) Create / authenticate user account, for example, using phone number and SMS verification; (1.3) Enter a user name (e.g., full name or nickname to show later in chat screen); (1.4) Land in the Avatars Selection screen or tab.

In the Avatars Selection screen or tab, for example: (2.1) Select an avatar from list of avatars or characters, and optionally purchase premium avatars; (2.2) Tap and hold for recording (“hold to talk” button), release to stop the recording and continue; optionally showing a timer or a counting-down indication for the time limit of recording (e.g., up to 15 or 20 or 30 seconds); (2.3) animation sequence or video sequence is being processed from audio recording (e.g., performed locally within the smartphone or within the end-user device, and/or performed remotely via a remote server or cloud-computing server); (2.4) The composing user/the sending user may review the resulting clip or animation sequence, and may choose to approve it or to re-try/re-record a different audio; (2.5) Sending the video file or animation sequence, via media delivery supporting applications or via content sharing or content distribution applications, or via an integrated communication module; (2.6) After the file was sent, return to the Avatars screen. Optionally, show a Settings menu or other button or link, allowing the user to: (2.7.1) create a new animation sequence; (2.7.2) browse previously-created animations, play them, share them, send them; (2.7.3) modify settings of the application.

In a Chat tab or screen, for example: (3.1) selecting “create new conversation” icon (top right) will open contact list for selection; (3.1.1) Once selected, user can now choose avatar, record and hear messages; (3.2) selecting to Edit may allow deleting chat boxes.

In the Contacts tab or screen, for example: (4.1) Allow user to view and edit contacts; (4.1.1) User may start a conversation with a selected contact, or with a group of multiple contacts; (4.1.2) If contact is not recognized with the Application, ask to send that recipient an invitation.

In the Settings tab or screen, for example: (5.1) display About information; (5.2) Tell a friend about the application or service; (5.3) edit the user's profile, including name or nickname; (5.4) Account management options, delete account, change phone number (to allow migration of the account to a new phone device or phone account), manage blocked contacts); (5.5) edit Notifications (e.g., new message, alerts) and edit other settings (e.g., sound on/off, vibration effect on/off); (5.6) Perform other operations (e.g., delete all chats; export chats).

In some embodiments, the sending-device or the composing-device may be a smart-watch or other wearable electronic device; and the flow of operations may be, for example: (1.1) Tapping on app icon will lead to a contact selection; (1.2) Once a contact is selected, optionally select an avatar from a list of avatars, and then move to recording mode; (1.3) Tap “record” for a 30-second count-down indicator, and record an audio message; (1.4) Tap “stop” to save recording and continue; (1.5) Tap “cancel” to return and record a new message, or tap “send” to send recording to selected recipient(s) or to distribution/sharing channel(s); (1.6) Show in notification, “Message Sent!” or “Animation sequence sent!”; (1.6.1) Tap “send another” and return to contact selection; (1.6.2) Tap “dismiss” to leave, namely, return to smart-watch menu and leave the app.

Similarly, on a receiver-device that is a smart-watch or other wearable electronic device, for example: (2.1) When receiving a message, show a notification containing the author's name with string “Sent you an Animated Message”; (2.2) Click on the notification, to play the animated message; (2.3) Click “Reply” to open the app at its recording screen.

In some embodiments, the audio segment may be sent from the mobile device to the server; the video or animation is rendered or generated on the server; and the video or animation is then sent to the sending party and to the recipient party. In other embodiments (e.g., if the sending device and/or the receiver device does not support video playback), the audio segment may be sent to the server (e.g., while also keeping a local recorded copy of the audio segment, stored locally on the sender's device); the server renders the video or animation; the server sends to the sender device and/or to the recipient device(s), a meta-data file (e.g., JSON) with phoneme names and with timeline; and each end-user device (of the recipient, and of the sender) may play-back the animation sequence by displaying the appropriate images at the right timing scheme in parallel to playing the audio segment.

Some embodiments may be implemented by using a suitable combination or hardware components, software modules, processor, CPU, Integrated Circuits, logic circuits, controllers, memory unit, storage unit, input unit, output unit, wired or wireless transceivers or transmitters or receivers or links or networks, or the like. Some embodiments may utilize client-side modules and/or server-side modules and/or client/server architecture and/or peer-to-peer architecture and/or distributed architecture. Some embodiments may perform calculations and/or may store data locally, within the end-user device, at a remote server, in a “cloud computing” device or server, or the like.

In some embodiments, a method may comprise: (a) recording an audio segment uttered by a user of an electronic device; (b) receiving from said user, a selection of a particular graphical avatar; wherein said particular graphical avatar is associated with a set of images; wherein each image of said set of images shows said particular graphical avatar with a different facial gesture; (c) analyzing said audio segment by applying a phonemes recognition technique; (d) generating a sequence of ordered audio phonemes that correspond to said audio segment; (e) for each recognized audio phoneme in said sequence, selecting from said set of images, that are associated with said particular graphical avatar, an image which shows said particular graphical avatar performing a facial gesture that matches said recognized audio phoneme; (f) generating a digital data-item that enables a playback module to playback an animated sequence that matches said audio segment.

In some embodiments, step (g) of generating a digital data-item comprises: generating a stand-alone integrated audio/video clip that contains said animated sequence.

In some embodiments, step (g) of generating a digital data-item comprises: generating a digital data-item that indicates: (A) which images were selected for said ordered audio phonemes, and (B) an order for displaying the selected images, and (C) a time period for displaying each one of said selected images.

In some embodiments, step (g) of generating a digital data-item comprises: generating an Extensible Markup Language (XML) data-item that indicates: (A) which images were selected for said ordered audio phonemes, and (B) an order for displaying the selected images, and (C) a time period for displaying each one of said selected images.

In some embodiments, the method may further comprise: (h) distributing said stand-alone integrated audio/video clip to one or more recipients selected by said user. In some embodiments, the distributing may comprise: distributing said stand-alone integrated audio/video clip to one or more recipients selected by said user, via at least one of: a real-time audio/video message exchange platform, a video conference platform, a chat platform, a content-item sharing platform, a content-item distribution platform.

In some embodiments, said electronic device comprises a smartphone; wherein step (a) of recording the audio segment comprises: obtaining said audio segment from a voice-message that said user utters via said smartphone through a voice-messaging system.

In some embodiments, said electronic device comprises a smartphone; wherein step (a) of recording the audio segment comprises: (i) intercepting a voice-message that said user utters via said smartphone through a voice-messaging system; (ii) extracting said audio-segment from said intercepted voice-message that said user uttered; wherein the method further comprises: wirelessly transmitting to an intended recipient of said voice-message, said digital data-item that enables a remote smartphone of said intended recipient to playback said animated sequence that matches said audio segment.

In some embodiments, said electronic device comprises a smartphone; wherein step (a) of recording the audio segment comprises: (i) intercepting a voice-message that said user utters via said smartphone through a voice-messaging system; (ii) extracting said audio-segment from said intercepted voice-message that said user uttered; wherein the method further comprises: (A)wirelessly transmitting to an intended recipient of said voice-message, said digital data-item that enables a remote smartphone of said intended recipient to playback said animated sequence that matches said audio segment; (B) transmitting wirelessly from to said remote smartphone of said intended recipient, a push notification that indicates to the remote smartphone that a new animation sequence coupled to a new audio voice-message are available for playback. In some embodiments, the method may further comprise: (C) receiving from the remote smartphone of the intended recipient, a wireless confirmation signal indicating a download request of said intended recipient; (D) only after receiving said wireless confirmation signal from said remote smartphone, transmitting wirelessly to the remote smartphone device said digital data-item that enables said remote smartphone to playback the animated sequence that matches said audio segment.

In some embodiments, the method may further comprise: storing in a database, that is associated with said electronic device, (A) multiple representations of graphical avatars that are user-selectable; and (B) for each graphical avatar, a set of multiple images such that each image shows said graphical avatar with a different facial gesture that corresponds to a different audio phoneme.

In some embodiments, the method may further comprise: (A) receiving from said user of said electronic device, a request to select a graphical avatar from a set of multiple user-selectable graphical avatars; (B) allocating to said user of the first portable electronic device, (i) a selected graphical avatar that said user selected, and (ii) a set of images that show said graphical avatar with different facial gestures that correspond to different audio phonemes.

In some embodiments, the method may further comprise: automatically inserting into said animation sequence, an animation effect of a facial gesture based on a pre-defined rule that dictates at least (a) a pre-defined timing scheme for automatic insertion of facial gestures, and (b) which facial gestures to automatically insert.

In some embodiments, the method may further comprise: automatically inserting into said animation sequence, an animation effect of a facial gesture based on a pre-defined rule that dictates to automatically insert a particular facial gesture once in every K seconds of animation, wherein K is a positive number.

In some embodiments, the method may further comprise: automatically inserting into said animation sequence, an animation effect of a facial gesture based on a pre-defined rule that dictates to automatically insert a particular facial gesture once in every K phonemes, wherein K is a positive number.

In some embodiments, the method may further comprise: automatically inserting by said server computer into said animation sequence, an animation effect of a facial gesture based on a pre-defined rule that dictates to automatically insert a particular facial gesture in pseudo-random locations along the animation sequence.

In some embodiments, said audio segment is initially recorded by utilizing a first audio codec; wherein the method comprises: producing said animated sequence which comprises said audio-segment trans-coded by utilizing a second, different, audio codec.

In some embodiments, the method may further comprise: receiving from said electronic device, an indication of a genre to which said audio segment belongs; selecting from a repository of animation effects, a particular animation effect that matches said genre; inserting said particular animation effect into the animation sequence generated for recognized phonemes of said audio segment.

In some embodiments, the method may further comprise: performing contextual analysis of a text message that was composed on said electronic device, to deduce a genre to which said audio segment belongs; selecting from a repository of animation effects, a particular animation effect that matches said genre of said audio segment; inserting said particular animation effect into the animation sequence generated for recognized phonemes of said audio segment.

In some embodiments, the method may further comprise: performing speech-to-text conversion of said audio segment to automatically generate a transcript of said audio segment; performing analysis of said transcript of said voice-message, to deduce a genre to which said audio segment belongs; selecting from a repository of animation effects, a particular animation effect that matches said genre; inserting said particular animation effect into the animation sequence generated for recognized phonemes of said audio segment.

In some embodiments, a device or a system may comprise: (a) an audio-recording module to record an audio segment uttered by a user of an electronic device; (b) an avatar-selection module to receive from said user, a selection of a particular graphical avatar; wherein said particular graphical avatar is associated with a set of images, wherein each image of said set of images shows said particular graphical avatar with a different facial gesture; (c) an audio analyzer module to analyze said audio segment by applying a phonemes recognition technique; (d) a sequence generator module to generate a sequence of ordered audio phonemes that correspond to said audio segment; (e) an image selector module configured to select, for each recognized audio phoneme in said sequence, from said set of images that are associated with said particular graphical avatar, an image (or at least one image; or one-or-more images) which shows said particular graphical avatar performing a facial gesture that matches said recognized audio phoneme; (f) an animation generator to generate a digital data-item that enables a playback module to playback an animated sequence that matches said audio segment.

In some embodiments, a method may comprise: (a) at a server computer, receiving a first wireless communication signal with digital audio data of a voice-message that was recorded on a first portable electronic device, wherein the first portable electronic device is associated with a particular graphical avatar, wherein said particular graphical avatar is associated with a set of images, each image showing said particular graphical avatar with a different facial gesture; (b) analyzing said digital audio data by utilizing a phonemes recognition technique; (c) generating a sequence of ordered audio phonemes that correspond to said digital audio data; (d) for each recognized audio phoneme in said sequence, selecting from said set of images, that are associated with said particular graphical avatar, an image which shows said particular graphical avatar performing a facial gesture that matches said recognized audio phoneme; (e) generating a digital representation that enables a playback module to playback an animated sequence that matches said digital audio data of said voice message, wherein the generated digital representation indicates: (A) which images were selected for said ordered audio phonemes, and (B) an order for displaying the selected images, and (C) a time period for displaying each one of said selected images.

In some embodiments, the method may comprise: transmitting wirelessly from the server computer to a second portable electronic device, said digital representation that indicates: (A) which images were selected for said ordered audio phonemes, and (B) the order for displaying the selected images, and (C) the time period for displaying each one of said selected images.

In some embodiments, the method may further comprise: transmitting wirelessly from the server computer to the second portable electronic device, said set of images that are associated with said particular graphical avatar.

In some embodiments, the method may further comprise: (i) transmitting wirelessly from the server computer to the second portable electronic device, a push notification that indicates to the second portable electronic device that a new animation sequence coupled to a new audio voice-message are available for downloading; (ii) receiving from the second portable electronic device a wireless confirmation signal indicating a download request of a user of the second portable electronic device; (iii) transmitting wirelessly from the server computer to the second portable electronic device, (I) the digital audio data of the voice-message and (II) said digital representation that indicates: (A) which images were selected for said ordered audio phonemes, and (B) the order for displaying the selected images, and (C) the time period for displaying each one of said selected images.

In some embodiments, the method may further comprise: storing in a database, that is associated with said server computer, (A) multiple representations of graphical avatars that are user-selectable; and (B) for each graphical avatar, a set of multiple images such that each image shows said graphical avatar with a different facial gesture that corresponds to a different audio phoneme.

In some embodiments, the method may further comprise: receiving a user of the first portable electronic device, a request to select a graphical avatar from a set of multiple user-selectable graphical avatars; allocating to said user of the first portable electronic device, a selected graphical avatar that said user selected, and a set of images that show said graphical avatar with different facial gestures that correspond to different audio phonemes.

In some embodiments, the method may further comprise: automatically inserting by said server computer into said animation sequence, an animation effect of a facial gesture based on a pre-defined rule that dictates when to automatically insert facial gestures and which facial gestures to insert.

In some embodiments, the method may further comprise: automatically inserting by said server computer into said animation sequence, an animation effect of a facial gesture based on a pre-defined rule that dictates to automatically insert a particular facial gesture once in every K seconds of animation, wherein K is a positive number.

In some embodiments, the method may further comprise: automatically inserting by said server computer into said animation sequence, an animation effect of a facial gesture based on a pre-defined rule that dictates to automatically insert a particular facial gesture once in every K phonemes, wherein K is a positive number.

In some embodiments, the method may further comprise: automatically inserting by said server computer into said animation sequence, an animation effect of a facial gesture based on a pre-defined rule that dictates to automatically insert a particular facial gesture in pseudo-random locations along the animation sequence.

In some embodiments, the method may further comprise: receiving from the first portable electronic device, meta-data that accompanies said digital audio data of the voice-message; wherein the meta-data indicates at least: (A) identification of a sender of the voice-message; and (B) identification of an intended recipient of the voice-message.

In some embodiments, the method may further comprise: receiving from the first portable electronic device, said digital audio data of the voice-message, wherein the digital audio data is encoded using a first audio codec; at said server computer, trans-coding the digital audio data from being encoded with said first audio codec to being encoded with a second audio codec; wirelessly transmitting from said server computer to a second portable electronic device, said voice-message being encoded with the second audio codec, together with representation of the animation sequence that corresponds to recognized audio phonemes of said voice-message.

In some embodiments, the method may further comprise: receiving from the first portable electronic device, an indication of a genre to which said voice-message belongs; selecting from a repository of animation effects, a particular animation effect that matches said genre of said voice-message; inserting said particular animation effect into the animation sequence generated for recognized phonemes of said voice-message.

In some embodiments, the method may further comprise: performing contextual analysis of a text message that was composed on said first portable electronic device, to deduce a genre to which said voice-message belongs; selecting from a repository of animation effects, a particular animation effect that matches said genre of said voice-message; inserting said particular animation effect into the animation sequence generated for recognized phonemes of said voice-message.

In some embodiments, the method may further comprise: performing speech-to-text conversion of said voice-message to automatically generate a transcript of said voice-message; performing textual analysis of said transcript of said voice-message, to deduce a genre to which said voice-message belongs; selecting from a repository of animation effects, a particular animation effect that matches said genre of said voice-message; inserting said particular animation effect into the animation sequence generated for recognized phonemes of said voice-message.

In some embodiments, the method may further comprise: wirelessly transmitting from the server computer, to a second portable electronic device, data comprising: (A) the digital audio of said voice-message; (B) the set of images that show the particular graphical avatar with different facial gestures corresponding to different audio phonemes; (C) an ordered and timed list of audio phonemes that correspond to said voice-message divided into discrete audio phonemes.

In some embodiments, the method may further comprise: wirelessly transmitting from the server computer, to a second portable electronic device, data comprising: (A) the digital audio of said voice-message; (B) data indicating which images to use from a repository of images pre-stored on the second portable electronic device, out of a set of images that show the particular graphical avatar with different facial gestures corresponding to different audio phonemes; (C) an ordered and timed list of audio phonemes that correspond to said voice-message divided into discrete audio phonemes.

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A method comprising:
(a) recording an audio segment uttered by a user of an electronic device;
(b) receiving from said user, a selection of a particular graphical avatar;
wherein said particular graphical avatar is associated with a set of images,
wherein each image of said set of images shows said particular graphical avatar with a different facial gesture;
(c) analyzing said audio segment by applying a phonemes recognition technique;
(d) generating a sequence of ordered audio phonemes that correspond to said audio segment;
(e) for each recognized audio phoneme in said sequence, selecting from said set of images, that are associated with said particular graphical avatar, an image which shows said particular graphical avatar performing a facial gesture that matches said recognized audio phoneme;
(f) generating a digital data-item that enables a playback module to playback an animated sequence that matches said audio segment.

2. The method of claim 1, wherein step (g) of generating a digital data-item comprises:
generating a stand-alone integrated audio/video clip that contains said animated sequence.

3. The method of claim 1, wherein step (g) of generating a digital data-item comprises:
generating a digital data-item that indicates: (A) which images were selected for said ordered audio phonemes, and (B) an order for displaying the selected images, and (C) a time period for displaying each one of said selected images.

4. The method of claim 1, wherein said electronic device is a device selected from the group consisting of: a smartphone, a tablet, a smart-watch, a wearable electronic device.

5. The method of claim 1, further comprising:
(h) distributing said stand-alone integrated audio/video clip to one or more recipients selected by said user, via at least one of: a real-time audio/video message exchange platform, a video conference platform, a chat platform, a content-item sharing platform, a content-item distribution platform.

6. The method of claim 1, wherein said electronic device comprises a smartphone;
wherein step (a) of recording the audio segment comprises: obtaining said audio segment from a voice-message that said user utters via said smartphone through a voice-messaging system.

7. The method of claim 1, wherein said electronic device comprises a smartphone;
wherein step (a) of recording the audio segment comprises:
(i) intercepting a voice-message that said user utters via said smartphone through a voice-messaging system;
(ii) extracting said audio-segment from said intercepted voice-message that said user uttered;
wherein the method further comprises:
wirelessly transmitting to an intended recipient of said voice-message, said digital data-item that enables a remote smartphone of said intended recipient to playback said animated sequence that matches said audio segment.

8. The method of claim 1, wherein said electronic device comprises a smartphone;
wherein step (a) of recording the audio segment comprises:
(i) intercepting a voice-message that said user utters via said smartphone through a voice-messaging system;
(ii) extracting said audio-segment from said intercepted voice-message that said user uttered;
wherein the method further comprises:
(A) wirelessly transmitting to an intended recipient of said voice-message, said digital data-item that enables a remote smartphone of said intended recipient to playback said animated sequence that matches said audio segment;
(B) transmitting wirelessly from to said remote smartphone of said intended recipient, a push notification that indicates to the remote smartphone that a new animation sequence coupled to a new audio voice-message are available for playback.

9. The method of claim 8, further comprising:
(C) receiving from the remote smartphone of the intended recipient, a wireless confirmation signal indicating a download request of said intended recipient;
(D) only after receiving said wireless confirmation signal from said remote smartphone, transmitting wirelessly to the remote smartphone device said digital data-item that enables said remote smartphone to playback the animated sequence that matches said audio segment.

10. The method of claim 1, further comprising:
storing in a database, that is associated with said electronic device,
(A) multiple representations of graphical avatars that are user-selectable; and
(B) for each graphical avatar, a set of multiple images such that each image shows said graphical avatar with a different facial gesture that corresponds to a different audio phoneme.

11. The method of claim 1, further comprising:
(A) receiving from said user of said electronic device, a request to select a graphical avatar from a set of multiple user-selectable graphical avatars;
(B) allocating to said user of the first portable electronic device, (i) a selected graphical avatar that said user selected, and (ii) a set of images that show said graphical avatar with different facial gestures that correspond to different audio phonemes.

12. The method of claim 1, further comprising:
automatically inserting into said animation sequence, an animation effect of a facial gesture based on a pre-defined rule that dictates at least (a) a pre-defined timing scheme for automatic insertion of facial gestures, and (b) which facial gestures to automatically insert.

13. The method of claim 1, further comprising:
automatically inserting into said animation sequence, an animation effect of a facial gesture based on a pre-defined rule that dictates to automatically insert a particular facial gesture once in every K seconds of animation, wherein K is a positive number.

14. The method of claim 1, further comprising:
automatically inserting into said animation sequence, an animation effect of a facial gesture based on a pre-defined rule that dictates to automatically insert a particular facial gesture once in every K phonemes, wherein K is a positive number.

15. The method of claim 1, further comprising:
automatically inserting by said server computer into said animation sequence, an animation effect of a facial gesture based on a pre-defined rule that dictates to automatically insert a particular facial gesture in pseudo-random locations along the animation sequence.

16. The method of claim 1, wherein said audio segment is initially recorded by utilizing a first audio codec;
wherein the method comprises:
producing said animated sequence which comprises said audio-segment trans-coded by utilizing a second, different, audio codec.

17. The method of claim 1, further comprising:
receiving from said electronic device, an indication of a genre to which said audio segment belongs;
selecting from a repository of animation effects, a particular animation effect that matches said genre;
inserting said particular animation effect into the animation sequence generated for recognized phonemes of said audio segment.

18. The method of claim 1, further comprising:
performing contextual analysis of a text message that was composed on said electronic device, to deduce a genre to which said audio segment belongs;
selecting from a repository of animation effects, a particular animation effect that matches said genre of said audio segment;
inserting said particular animation effect into the animation sequence generated for recognized phonemes of said audio segment.

19. The method of claim 1, further comprising:
performing speech-to-text conversion of said audio segment to automatically generate a transcript of said audio segment;
performing analysis of said transcript of said voice-message, to deduce a genre to which said audio segment belongs;
selecting from a repository of animation effects, a particular animation effect that matches said genre;
inserting said particular animation effect into the animation sequence generated for recognized phonemes of said audio segment.

20. A device comprising:
(a) an audio-recording module to record an audio segment uttered by a user of an electronic device;
(b) an avatar-selection module to receive from said user, a selection of a particular graphical avatar;
wherein said particular graphical avatar is associated with a set of images,
wherein each image of said set of images shows said particular graphical avatar with a different facial gesture;
(c) an audio analyzer module to analyze said audio segment by applying a phonemes recognition technique;
(d) a sequence generator module to generate a sequence of ordered audio phonemes that correspond to said audio segment;
(e) an image selector module configured to select, for each recognized audio phoneme in said sequence, from said set of images that are associated with said particular graphical avatar, an image which shows said particular graphical avatar performing a facial gesture that matches said recognized audio phoneme;
(f) an animation generator to generate a digital data-item that enables a playback module to playback an animated sequence that matches said audio segment.
